(19) United States
(12) Patent Application Publication
(10) Pub. No.: US 2010/0046385 A1
(43) Pub. Date: Feb. 25, 2010

(54) Wireless Communication Terminal, Communication Control Method of Wireless Communication Terminal, and Wireless Communication System

(75) Inventors: Tasuku Kamei, Kanagawa (JP); Junichi Furumi, Kanagawa (JP); Hideki Okamoto, Kanagawa (JP); Futoshi Ishihara, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/447,878

(22) PCT Filed: Oct. 30, 2007
(86) PCT No.: PCT/JP2007/071079

§ 371 Date: Apr. 29, 2009

(30) Foreign Application Priority Data
Oct. 30, 2006 (JP) 2006-294928
Oct. 30, 2006 (JP) 2006-294992
Oct. 30, 2006 (JP) 2006-294998
Oct. 30, 2006 (JP) 2006-295000

(51) Int. Cl. H04W 4/00; H04L 12/26

(52) U.S. Cl. 370/252; 370/328

(57) ABSTRACT

It is possible to provide a radio communication terminal, a radio communication terminal communication control method, and a radio communication system, capable of effectively performing acquisition of a communication system and trying connection by a communication method desired by a user when a transmission process is generated even if the state is judged to be out-of-cell. When a communication start request is made in the state of out-of-cell in which communication is disabled, a control unit (18) performs an acquisition process start instruction instructing a communication unit (11) to acquire one of communication systems. The communication unit (11) performs a first acquisition process for performing capture by a first procedure when the acquisition process is performed according to the acquisition process start instruction generated within a predetermined time after the state has become out-of-cell and performs a second acquisition for performing acquisition by a second procedure which is different from the first procedure when the acquisition process is performed according to the acquisition process start instruction generated after a predetermined time has elapsed after the state has become out-of-cell.

### TECHNICAL FIELD

The present invention relates to a wireless communication terminal, a communication control method of a wireless communication terminal, and a wireless communication system, which are applicable to, for example, a multiband wireless communication system.

### BACKGROUND ART

A wireless communication terminal applied to, for example, CDMA (Code Division Multiple Access) communication starts a channel acquisition operation when sending or receiving a signal or when transferring data. Further, the terminal obtains configuration information and timing information of the acquired channel and obtains position registration information etc. synchronized with the timing of the acquired channel.

The received signal strength of this channel sometimes remarkably falls depending on an environment (topography, buildings, etc.) in which the wireless communication terminal is used. When the received signal strength of the channel is low, regardless of that the fact that the signal of the channel was received, the terminal judges that the channel could not be acquired, and shifts the processing to restitute processing.

In this restitute processing, the wireless communication terminal runs a system scan where the terminal acquires a channel by a predetermined cycle.

In this regard, when the wireless communication terminal is out of service area, the wireless communication terminal internally turns a flag showing it is “out-of-service-area” (out-of-service-area flag) ON. In such a situation, even if the user performs a send operation, the terminal will not start up the send processing since the possibility of transmission is low while the out-of-service-area flag is ON and in general for saving power.

Further, once the terminal is judged “out-of-service-area”, the restitute processing is carried out by a predetermined cycle, but the communication schemes for running a system scan for reset are limited and the time required for restitute processing can no longer be ignored.

For example, when exiting from or entering to a tunnel or at another where the environment used the terminal therein is extremely different, desirably the restitute processing is carried out immediately after exiting from the tunnel. However, immediate reset is not possible unless at the timing of an restitute acquisition operation. Further, even if the terminal performs the restitute acquisition processing, this does not always lead to an immediate restitute processing.

In order to overcome the problem described above, the art is known of performing a channel acquisition operation if performing a send operation even when the terminal is judged “out-of-service-area” (see, for example, Patent Document 1).

Patent Document 1: Japanese Patent Publication (A) No. 2003-23665

### DISCLOSURE OF THE INVENTION

### Problem to be Solved by the Invention

According to the art disclosed in the above Patent Document 1, the call success rate can be improved in restitute processing.

However, recently, it has become possible for one wireless communication terminal to use a plurality of frequency bands (for example, 800 MHz and 2 GHz). Further, wireless communication terminals able to handle a plurality of communication protocols (CDMA2000_{—}1x protocol, EVDO: Evolution Data Only) have been increasing.

Under such a situation, with just restitute acquisition processing of a plurality of channels for a single communication system, the signal will not necessarily be sent by the communication scheme desired by the user.

The present invention provides a wireless communication terminal compliant with a plurality of communication schemes, a communication control method of a wireless communication terminal, and a wireless communication system, which efficiently perform acquisition of a communication system and which can attempt connection by the communication scheme desired by the user as much as possible when a wireless communication terminal performs a send operation even in a state judged “out-of-service-area”.

### Means for Solving the Problems

A wireless communication terminal of a first aspect of the present invention includes: a communication part capable of acquiring a plurality of communication systems and capable of executing communication by a communication protocol; and a control part which controls communication by the communication part at any of the plurality of communication systems using the communication protocol when a start of communication is instructed, wherein the control part sends to the communication part an acquisition instruction instructing acquisition of any of the plurality of communication systems when the start of communication is instructed in a state judged “out-of-service-area” in which communication cannot be carried out and performs control of acquisition processing in accordance with an elapsed time from when the “out-of-service-area” state was entered.

Preferably, the control part controls the communication part so as to perform a first acquisition processing of performing acquisition by a first routine when performing acquisition processing based on an acquisition instruction generated within a predetermined time from when the “out-of-service-area” state was entered and perform a second acquisition processing of performing acquisition by a second routine which is different from the first routine when performing acquisition processing based on an acquisition instruction generated exceeding the first predetermined time from when the “out-of-service-area” state was entered.

Preferably, the control part has a communication system selection part instructing the communication part of a communication system to be acquired, a protocol execution part instructing the communication part of acquisition according to a predetermined communication protocol, and an acquisition instruction function execution part sending to the communication system selection part an instruction for starting the acquisition processing of the communication system, the acquisition instruction function execution part sends to the communication system selection part an acquisition processing start instruction instructing acquisition of any of the plurality of communication systems when the start of communication is requested in a state judged “out-of-service-area” in which communication cannot be carried out and performs processing of the start of communication by a successfully acquired communication system when an acquisition success is informed for the acquisition processing start instruction, and the communication system selection part makes the protocol execution part perform a first acquisition processing for performing acquisition by the first routine when performing the acquisition processing based on the acquisition instruction generated within the first predetermined time from when the “out-of-service-area” state was entered and makes the protocol execution part perform a second acquisition processing for performing the acquisition by a second routine which is different from the first routine when performing the acquisition processing based on the acquisition instruction generated exceeding the first predetermined time from when the “out-of-service-area” state was entered.

Preferably, when making the acquisition instruction function execution part perform the acquisition processing, the control part judges if the time is over the first predetermined time by comparing a time when the communication start was requested and a time when the “out-of-service-area” state was shifted to.

Preferably, the acquisition instruction function execution part sends a new acquisition processing start instruction to the communication system selection part when an acquisition failure is informed from the communication system selection part for the acquisition instruction after performing the acquisition instruction.

Preferably, the acquisition instruction function execution part sends a new acquisition instruction to the communication system selection part when a success or failure of the acquisition is not informed from the communication system selection part for the acquisition processing start instruction after when the acquisition processing start instruction was sent to the communication system selection part and a second predetermined time has passed.

Preferably, the terminal includes a plurality of reference destinations at which communication systems which can be acquired are stored in different orders, and the communication system selection part switches reference destinations according to an elapsed time after shift to the “out-of-service-area” state and makes the protocol execution part perform either of the first acquisition processing or second acquisition processing based on the switched reference destination.

Preferably, the communication protocol includes a first communication protocol and a second communication protocol, the protocol execution part includes a first protocol execution part instructing the communication part of acquisition according to the first communication protocol and a second protocol execution part instructing the communication part of acquisition according to the second communication protocol, and the communication system selection part selects either of the first protocol execution part and second protocol execution part and makes it perform the acquisition processing.

Preferably, the control part controls the communication part so as to execute an acquisition attempt processing for n number of communication systems when an elapsed time from the shift to the “out-of-service-area” state to a generation of a communication start request is a first time and execute the acquisition attempt processing for m (where m>n) number of communication systems when it is a second time shorter than the first time.

Preferably, the control part has a communication system selection part instructing the communication part of a communication system to be acquired, a protocol execution part instructing the communication part of acquisition according to the communication protocol, and an acquisition instruction function execution part sending to the communication system selection part an acquisition attempt processing start instruction of the communication system, the acquisition instruction function execution part sends to the communication system selection part an acquisition attempt processing start instruction instructing acquisition of any of the plurality of communication systems when the communication start is requested in a state judged “out-of-service-area” in which communication cannot be carried out and sends to the communication system selection part an acquisition attempt processing start instruction instructing acquisition of any of the plurality of communication systems again when a predetermined has passed from when the acquisition attempt processing start instruction was sent before an acquisition success for the acquisition attempt processing start instruction is informed, and performs processing of the start of communication by the successfully acquired communication system when an acquisition success is informed for the acquisition attempt processing start instruction, and the communication system selection part monitors the time when the acquisition attempt processing start instruction is sent from the acquisition instruction function execution part and the acquisition attempt processing is carried out and makes the protocol execution part execute an acquisition attempt processing for n number of communication systems when the elapsed time from when the shift to the “out-of-service-area” state was made to the generation of the communication start request is the first time and execute an acquisition attempt processing for m (where m>n) number of communication systems when the elapsed time is the second time.

Preferably, the communication system selection part performs an acquisition attempt processing acquiring the communication system in a state judged “out-of-service-area” and a state where the communication is not requested and repeatedly executes an in-area reset processing for shifting to an in-area state until reset to in-area state at a predetermined time interval when the acquisition succeeds and repeats the in-area reset processing by a predetermined cycle when the elapsed time from the shift to the “out-of-service-area” state to when the communication start request is generated is the first time and performs the in-area reset processing at an interval longer than the predetermined cycle when the elapsed time is the second time.

Preferably, the control part instructs the communication part of an acquisition attempt processing so as to acquire a plurality of communication systems in a predetermined order when the communication start is requested in a state judged “out-of-service-area” in which communication cannot be carried out, and the communication part repeats the acquisition attempt processing N number of times when the predetermined time has not passed from when an “out-of-service-area” state is judged and repeatedly executes the acquisition attempt processing M number of times (where N>M) when the predetermined time has passed.

Preferably, the control part has a communication system selection part instructing the communication part of a communication system to be acquired, a protocol execution part instructing the communication part of acquisition according to the communication protocol, and an acquisition instruction function execution part sending to the communication system selection part an acquisition attempt processing start instruction of the communication system, the acquisition instruction function execution part sends to the communication system selection part an acquisition attempt processing start instruction instructing acquisition of any of the plurality of communication systems in the predetermined order when the communication start is requested in a state judged “out-of-service-area” and sends to the communication system selection part the acquisition attempt processing start instruction again when the predetermined time has passed before an acquisition success is informed for the acquisition attempt processing start instruction and performs processing of the start of communication by the successfully acquired communication system when an acquisition success is informed for the acquisition attempt processing start instruction, and the communication system selection part makes the protocol execution part execute the acquisition attempt processing so as to repeat the acquisition attempt processing N number of times when the predetermined time has not passed from when it was judged as the “out-of-service-area”state when the acquisition attempt processing start instruction is sent from the acquisition instruction function execution part and the acquisition attempt processing is carried out and repeat the acquisition attempt processing M number of times (where N>M) where the predetermined time has passed.

Preferably, the communication system selection part makes the protocol execution part execute the acquisition attempt processing so as to execute the acquisition attempt processing only one time (M=1) when the predetermined time has passed from when it was judged as the “out-of-service-area” state when the acquisition attempt processing start instruction is sent from the acquisition instruction function execution part and the acquisition attempt processing is carried out.

Preferably, the terminal further includes a display part, and the acquisition instruction function execution part makes the display part display a failure of a send operation when the request of the start of communication was based on a send operation by the user when instructing the communication system selection part to end the acquisition attempt processing.

Preferably, the control part instructs the communication part of an acquisition attempt processing of acquiring any of a plurality of communication systems when the start of communication is requested in a state judged “out-of-service-area” in which communication cannot be carried out and sets a time duration for which the acquisition attempt processing is continued in accordance with the elapsed time from when an “out-of-service-area” state is judged.

Preferably, the control part has a communication system selection part instructing the communication part of a communication system to be acquired, a protocol execution part instructing the communication part of acquisition according to the communication protocol, and an acquisition instruction function execution part sending to the communication system selection part an acquisition attempt processing start instruction of the communication system, the acquisition instruction function execution part sends to the communication system selection part an acquisition attempt processing start instruction instructing acquisition of any of the plurality of communication systems when the communication start is requested in a state judged “out-of-service-area” in which communication cannot be carried out and sends to the communication system selection part an acquisition attempt processing start instruction instructing acquisition of any of the plurality of communication systems again when a predetermined has passed from the acquisition attempt processing start instruction before an acquisition success is informed for the acquisition attempt processing start instruction and performs processing of the start of communication by the successfully acquired communication system when an acquisition success is informed for the acquisition attempt processing start instruction, and the communication system selection part makes the protocol execution part execute the acquisition attempt processing by the selected communication system based on the time duration when the acquisition attempt processing start instruction is sent from the acquisition instruction function execution part and the acquisition attempt processing is carried out.

Preferably, the terminal further includes a timer monitor part, and the acquisition instruction function execution part stepwise sets the time duration shorter in accordance with a length of the elapsed time counted by the timer monitor part.

Preferably, the terminal further includes a display part, and the acquisition instruction function execution part makes the display part display a failure of a send operation when completing the acquisition attempt processing based on the time duration and instructing the communication system selection part of ending of the acquisition attempt processing in a case where the request of the start of communication was based on the send operation by the user.

A second aspect of the present invention is a communication control method of a wireless communication terminal including: a communication part capable of acquiring a plurality of communication systems and capable of executing communication by a communication protocol; and a control part which controls communication by the communication part at any of the plurality of communication systems using the communication protocol when a start of communication is instructed, wherein the control part sends to the communication part of an acquisition instruction instructing acquisition of any of a plurality of communication systems when the start of communication is instructed in a state judged “out-of-service-area” in which communication cannot be carried out and performs control of the acquisition processing in accordance with the elapsed time from when the “out-of-service-area” state was entered.

A wireless communication system of a third aspect of the present invention includes: a base station; and a wireless communication terminal performing wireless communication with the base station through a channel assigned by the base station, wherein the wireless communication terminal has a communication part capable of acquiring a plurality of communication systems and capable of executing communication according to a communication protocol, and a control part which controls communication by the communication part at any of the plurality of communication systems using the communication protocol when a start of communication is instructed, wherein the control part sends to the communication part an acquisition instruction instructing acquisition of any of the plurality of communication systems when the start of communication is instructed in a state judged “out-of-service-area” in which communication cannot be carried out and performs control of the acquisition processing in accordance with the elapsed time from when the “out-of-service-area” state was entered.

### EFFECTS OF THE INVENTION

According to the present invention, even in a state judged “out-of-service-area”, a communication system is efficiently acquired when a send processing occurs, so it is possible to attempt connection according to the communication scheme desired by the user as much as possible.

### BRIEF DESCRIPTION OF THE DRAWINGS

FIG. 1 is a view of the system configuration showing a wireless communication system to which a wireless communication terminal according to an embodiment of the present invention is applied.

FIG. 2 is a diagram for explaining pattern sorting when a communication system is in an “out-of-service-area” state.

FIG. 3 is a diagram for explaining a relationship between an out-of-service-area mode and an out-of-service-area elapsed time.

FIG. 4 is a block diagram showing an example of the configuration of a wireless communication terminal according to first and second embodiments of the present invention.

FIG. 5 is a perspective view showing an example of the configuration of an outer appearance of a mobile phone serving as a wireless communication terminal according to an embodiment of the present invention.

FIG. 6 is an operation sequence diagram for explaining the operation of a wireless communication terminal according to the first embodiment of the present invention.

FIG. 7A and FIG. 7B are flow charts for explaining the operation of the wireless communication terminal according to the first embodiment of the present invention.

FIG. 8A and FIG. 8B are flow charts for explaining the operation of the wireless communication terminal according to the second embodiment of the present invention.

FIG. 9 is a block diagram showing an example of the configuration of a wireless communication terminal according to a third embodiment of the present invention.

FIG. 10 is an operation sequence diagram showing an out-of-service-area send operation 1 of a multiband wireless communication terminal in the third embodiment.

FIG. 11 is an operation sequence diagram for explaining an in-area reset processing by Tomarigi Search.

FIG. 12 is an operation sequence diagram for explaining the operation (out-of-service-area send operation 2) of the wireless communication terminal according to the third embodiment of the present invention.

FIG. 13 is a flow chart for explaining the operation of the wireless communication terminal according to the third embodiment of the present invention.

FIG. 14 is a block diagram showing an example of the configuration of a wireless communication terminal according to a fourth embodiment of the present invention.

FIG. 15 is a processing sequence diagram showing a send operation from out-of-service-area (1) of the multiband wireless communication terminal in the fourth embodiment.

FIG. 16 is a processing sequence diagram showing a send operation from out-of-service-area (2) of the multiband wireless communication terminal in the fourth embodiment.

FIG. 17 is a block diagram showing an example of the configuration of a wireless communication terminal according to a fifth embodiment of the present invention.

FIG. 18 is a flow chart showing a send operation 1 from out-of-service-area of the multiband wireless communication terminal in the fifth embodiment.

FIG. 19 is a flow chart for explaining the operation of the wireless communication terminal according to the fifth embodiment of the present invention.

FIG. 20 is a flow chart for explaining a selection operation of a re-try timer value in accordance with an out-of-service-area stay time of the wireless communication terminal according to the fifth embodiment of the present invention.

### EXPLANATION OF NOTATIONS

1 . . . wireless communication system, 10, 10A to 10D . . . wireless communication terminals, 11 . . . communication part, 12 . . . operation part, 13 . . . voice processing part, 14 . . . speaker, 15 . . . microphone, 16 . . . display part, 17 . . . memory part, 18 . . . control part, 181, 181B to 181D . . . key detection parts, 182, 182B to 182D . . . display control parts, 183, 183B to 183D . . . EVDO protocol execution parts (first protocol execution parts), 184, 184B to 184D . . . “1x” protocol execution parts (second protocol execution parts), 185, 185B to 185D . . . communication system selection parts, 186, 186B to 186D . . . acquisition instruction function execution parts, 1850 . . . scan list, 1860 . . . acquired result informing region, 20 . . . base station, 30 . . . communication network, and 40 . . . server apparatus.

### BEST MODE FOR CARRYING OUT THE INVENTION

Below, embodiments of the present invention will be explained with reference to the attached drawings.

First, a communication system to which a wireless communication terminal according to an embodiment of the present invention can be applied will be explained.

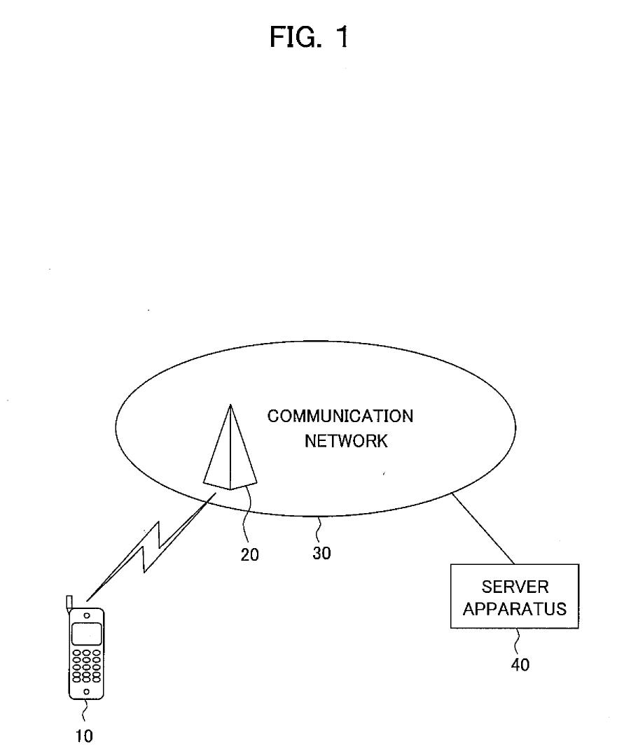

FIG. 1 is a view of the system configuration showing a wireless communication system to which a wireless communication terminal according to an embodiment of the present invention is applied.

A wireless communication system 1 is, as shown in FIG. 1, configured by a wireless communication terminal 10, base station 20, communication network 30, and server apparatus 40.

The wireless communication terminal 10 according to the present embodiment, as shown in FIG. 1, has a function of using the wireless communication part to request desired data via the base station 20 and through the communication network 30 to the server apparatus 40 and displaying Web data or other information obtained via the base station 20 in response to the request on the display part.

Note that, in the present embodiment, the explanation will be given illustrating a mobile phone as the wireless communication terminal. Note that, in the present embodiment, while the explanation is given illustrating a mobile phone as the wireless communication terminal, the embodiment can be applied to other wireless communication terminals as well.

In recent years, in the wireless communication system 1, effective utilization of the frequency bands used has been promoted. Reorganization of frequency bands has been studied for making the frequencies used match with standard global specifications.

For example, in a wireless communication system using CDMA2000_{—}1x protocol, at present, in Japan, the Japanese specification 800 MHz band (hereinafter, referred to as “the present 800 MHz band”) is being used. There are plans for reorganizing this frequency band to a new 800 MHz band of the standard global specification.

Note that, the present 800 MHz band and the new 800 MHz band differ in frequency assignment etc. between the uplink (communication from the wireless communication terminal 10 to the base station 20 side) and downlink (communication from the base station 20 side to the wireless communication terminal 10) in the frequency band used.

In view of this background, a multiband wireless communication terminal capable of communication, in the present frequency band (present 800 MHz), new frequency band (new 800 MHz), and high frequency band (2 GHz) is being developed.

A multiband wireless communication terminal 10 engages in wireless communication with the base station 20 through the channel assigned by the base station 20. At this time, the wireless communication terminal 10 can transmit and receive wireless signals in a plurality of frequency bands. Specifically, the wireless communication terminal 10 can transmit and receive wireless signals by using the existing frequency band (old 800 MHz), new frequency band (new 800 MHz), and high frequency band (2 GHz).

The above communication systems with different frequency bands are assigned identification numbers for the base station 20 and the wireless communication terminal 10 to discriminate the frequency bands constituted by the “band classes” prescribed in 3GPP2 (3rd Generation Partnership Project 2).

For example, in a list of nearby base stations etc. in information informed from the base station 20 to the wireless communication terminal 10, this band class is used for reporting the communication systems existing around the wireless communication terminal 10 and so on.

Note that, the existing frequency band (present 800 MHz) is classified as the “band class 3”, the new frequency band (new 800 MHz) is classified as the “band class 0”, and the high frequency band (2 GHz) is classified as the “band class 6”.

Further, each band class is assigned a primary channel and a secondary channel (however, only the primary channel in the EVDO communication of band class 6). Further, when considering the difference of protocols (EVDO), there are a total of 11 patterns of communication systems.

In the multiband wireless communication terminal 10 having the above 11 patterns of communication systems, here, as the standard for judging whether or not a send request issued in an out-of-service-area state is useless, an elapsed time when the out-of-service-area state is shifted to is used.

Due to this, by changing the acquisition routine of communication systems or the send processing method, suppression of battery consumption is achieved securing sending opportunities.

The range in which one base station 20 can communicate is limited (is determined according to its performance and the network configuration). The wireless communication terminal 10 can communicate so long as it is located within this range.

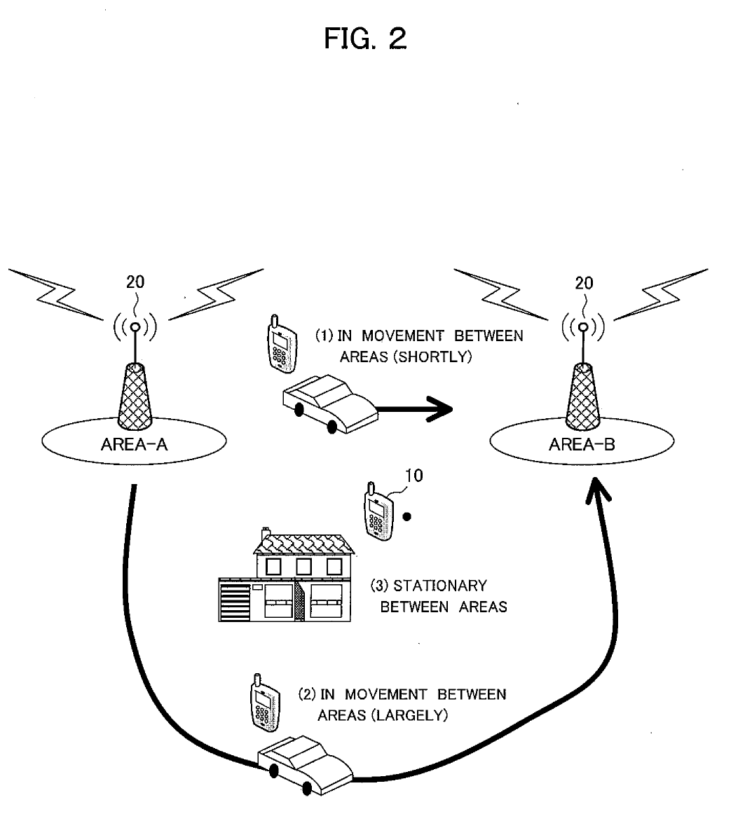

The state where the wireless communication terminal 10 is out-of-service-area is considered to be included in any of three situations of, for example, as shown in FIG. 2, (1) movement between areas (a little out-of-service-area), (2) movement between areas (largely out-of-service-area), and (3) stationary between areas.

When the wireless communication terminal 10 is in movement a little out-of-service-area, the possibility that it will shortly move to an adjacent area and reset in-area is high. In this case, there is a possibility of success of a send operation even it is out-of-service-area. Accordingly, when receiving an out-of-service-area send request by the user, this must be processed and a send processing having a higher success rate must be selected and executed irrelevant to the battery consumption.

Further, when the wireless communication terminal 10 is stationary between areas or in movement out-of-service-area larger than the usual out-of-service-area state, the possibility of shortly being reset in-area. In this case, the possibility of success of a send operation is considered to be low. Accordingly, when receiving an out-of-service-area send request by the user, it must be ignored or send processing consuming the battery less must be selected and executed.

No means for easily and correctly learning in which situation among (1), (2), or (3) described above the wireless communication terminal 10 belongs has been discovered so far. Here, as the method for approximately finding this, the elapsed time from when the wireless communication terminal 10 shifted to the out-of-service-area state is used.

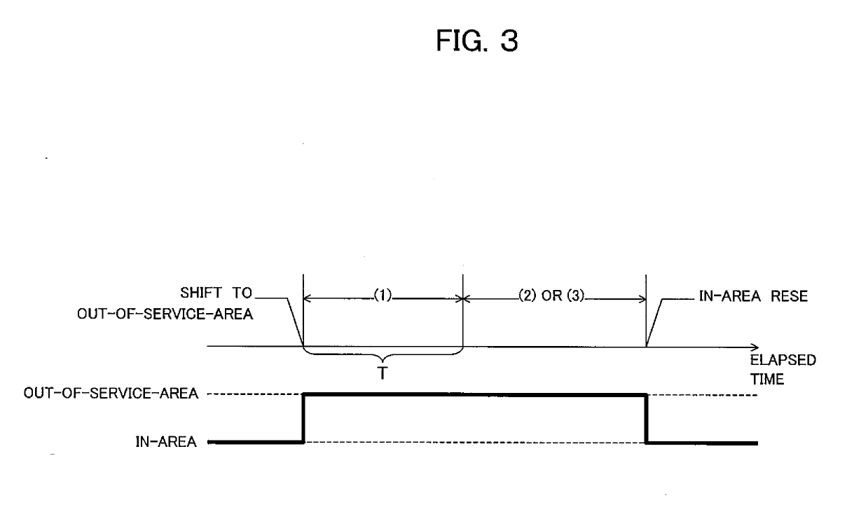

As shown in FIG. 3 in which the relationship between the state of shift to out-of-service-area and the out-of-service-area elapsed time is shown on a time axis, the longer the wireless communication terminal 10 is in the out-of-service-area state, the more stable the out-of-service-area state.

In the present embodiment, by paying attention to this fact, there is provided a wireless communication terminal 10 which can suppress the battery consumption while improving user friendliness by determining a period immediately after the shift to “out-of-service-area” to a certain time T as the situation of (1), approximating a period from the certain time T to the in-area reset to the situation of (2) or (3), and changing the send processing based on this judgment.

Here, “out-of-service-area” means the state where the wireless communication terminal can no longer acquire any communication system, the out-of-service-area flag is turned ON inside the wireless communication terminal, and “out-of-service-area” is displayed on the screen of the display part as an antenna picture, and the restitute processing is periodically executed.

Further, “in-area reset processing” means processing performing a system scan (reception frequency search) and, if there is a found frequency, judging whether or not a channel (communication system) is usable by analyzing a pilot signal informed in that frequency, acquiring the communication system when the pilot signal strength exceeds a predetermined level, and resetting to the communication enabled state (in area).

Below, first to fifth embodiments of the multiband wireless communication terminal 10 having the 11 patterns of communication systems described above will be explained in detail.

The wireless communication terminal 10 exemplified below basically has a communication part capable of acquiring a plurality of communication systems and capable of executing communication by a communication protocol and a control part which controls communication by the communication part by any of the plurality of communication systems using the communication protocol when a start of communication is instructed.

Then, basically, the control part sends to the communication part an acquisition instruction instructing acquisition of any of the plurality of communication systems when the communication start is instructed in a state judged “out-of-service-area” in which communication cannot be carried out and performs control of the acquisition processing in accordance with the elapsed time from when the “out-of-service-area” state was entered (when the “out-of-service-area” state was shifted to).

In the wireless communication terminal 10A according to the first and second embodiments, when performing the acquisition processing based on the acquisition instruction generated within a predetermined time from when the out-of-service-area state was entered, the control part controls the communication part so as to perform a first acquisition processing performing the acquisition by a first routine. Further, the control part controls the communication part so as to perform a second acquisition processing performing acquisition by a second routine which is different from the first routine when performing the acquisition processing based on the acquisition instruction generated exceeding the first predetermined time from when the out-of-service-area state was entered.

In a wireless communication terminal 10B according to a third embodiment, the control part executes the acquisition attempt processing for n number of communication systems when the elapsed time from when the out-of-service-area state was shifted to the generation of the communication start request is the first time. Further, the control part controls the communication part to execute the acquisition attempt processing for m (where m>n) number of communication systems when it is the second time shorter than the first time.

In a wireless communication terminal 10C according to a fourth embodiment, when the communication start is requested in a state judged “out-of-service-area” in which communication cannot be carried out, the control part instructs the communication part of acquisition attempt processing so as to acquire a plurality of communication systems in a predetermined order. Then, the control part controls the communication part so as to repeat the acquisition attempt processing N number of times when the predetermined time has not passed from when an “out-of-service-area” state is judged and repeatedly execute the acquisition attempt processing M number times (where N>M) when the predetermined time has passed.

In a wireless communication terminal 10D according to a fifth embodiment, the control part instructs the communication part of acquisition attempt processing for acquiring any of the plurality of communication systems when the start of communication is instructed in a state judged “out-of-service-area” in which communication cannot be carried out. Then, the control part sets the time duration for which this acquisition attempt processing is continued in accordance with the elapsed time from when an “out-of-service-area” state is judged.

The first to fifth embodiments of the wireless communication terminals having such features will be concretely explained below with reference to the drawings.

Note that it is also possible to configure wireless communication terminals explained below so that these individually have characteristic configurations and functions of the first to fifth embodiments or it is also possible to configure these by combining all or a portion of these.

First, the wireless communication terminals according to the first and second embodiments will be explained.

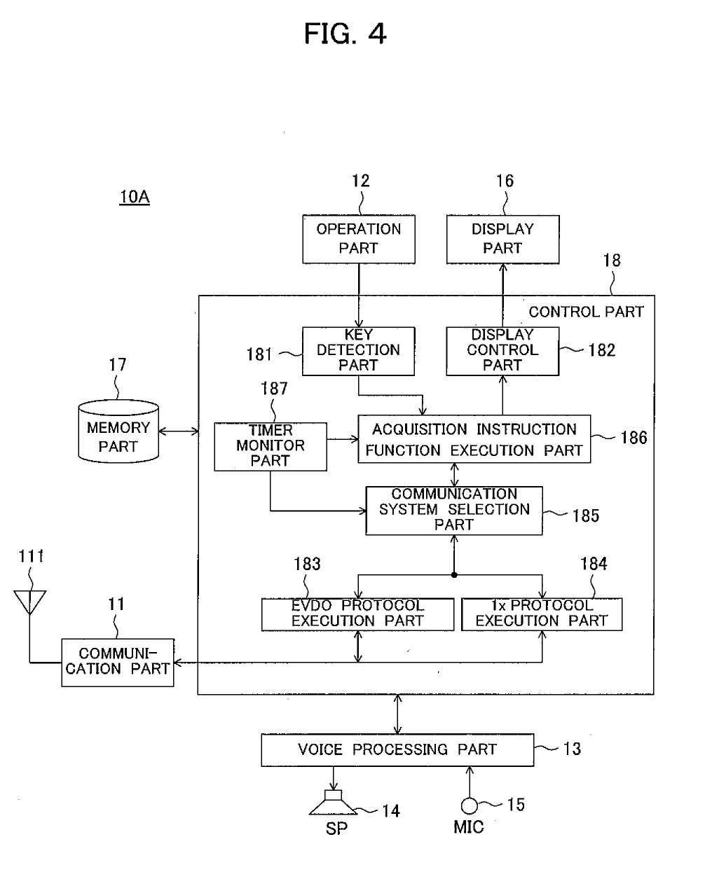

FIG. 4 is a block diagram showing an example of the configuration of the signal processing system of the wireless communication terminals according to the first and second embodiments of the present invention.

Here, the functional blocks of a signal processing system in a mobile phone used as the wireless communication terminal 10A will be illustrated as described above.

This wireless communication terminal 10A embodied as a mobile phone has a communication part 11, operation part 12, voice processing part 13, speaker 14, microphone 15, display part 16, memory part 17, and control part 18.

The communication part 11 acquires a plurality of communication systems and engages in wireless communication with the base station 20 connected to the communication network 30 according to a first communication protocol (for example EVDO) and a second communication protocol (for example CDMA2000_{—“}1x” protocol: hereinafter, abbreviated as “1x” protocol).

Note that, EVDO communication is faster than “1x” communication. “1x” communication has the feature of supporting voice communication as well unlike EVDO communication.

The communication part 11 applies predetermined modulation processing to transmission data output by the control part 18 to convert this to a wireless signal which it then transmits via an antenna 111. Further, it applies predetermined demodulation processing to a wireless signal from the base station 20 received at the antenna 111 to convert this to reception data which it then outputs to the control part 18.

As characteristic functions of the first and second embodiments, the communication part has a function of performing the first acquisition processing for acquisition under the control part 18 by a first routine as will be explained later when performing the acquisition processing based on the acquisition instruction generated in a predetermined time from when the out-of-service-area state was entered. Further, the communication part 11 has a function of performing the second acquisition processing for acquisition under the control part 18 by a second routine different from the first routine when performing the acquisition processing based on the acquisition instruction generated exceeding the predetermined time from when the out-of-service-area state was entered. Details will be explained later.

The operation part 12 has, for example, a power key, speak key, number keys, letter keys, direction keys, an execute key, a send key, and other keys to which various functions are assigned. When these keys are operated by the user, the operation part 12 generates signals corresponding to those operation contents and inputs these as an instruction of the user to the control part 18.

The voice processing part 13 processes an audio signal output from the speaker 14 and audio signal input from the microphone 15.

Namely, the voice processing part 13 amplifies voice input from the microphone 15, performs analog-to-digital conversion, and further applies encoding or other signal processing to this to convert it to digital audio data and outputs the result to the control part 18.

Further, the voice processing part 13 applies decoding, digital-to-analog conversion, amplification, or other signal processing to the audio data supplied from the control part 18 to convert the same to an analog audio signal and outputs the result to the speaker 14.

The display part 16 is configured by using, for example, a liquid crystal display panel, an organic EL (Electro-Luminescence) panel, or other display device and displays an image in accordance with a video signal supplied from the control part 18.

The display part 16 displays, for example, a phone number of a destination at the time of a send operation, a phone number of the other party at the time of the reception, contents of received mail and transmitted mail, the date, time, remaining battery power, success of a send operation, a waiting screen, and other various information and images.

The memory part 17 stores various types of data utilized for the processing in the control part 18.

The memory part 17 holds, for example, a program of a computer provided in the control part 18, an address book for managing personal information such as phone numbers and e-mail addresses of other parties, an audio file for playing back an incoming call sound and an alarm sound, an image file for the waiting screen, various types of setting data, temporary data utilized in the processing process of the program, and so on.

Note that, the above memory part 17 is configured by, for example, a nonvolatile memory device (nonvolatile semiconductor memory, hard disc device, optical disc device, etc.), a random accessible memory device (for example, SRAM or DRAM), or the like.

The control part 18 centrally controls the entire operation of the mobile phone.

Namely, the control part 18 controls operations of blocks explained above so that various types of processing of the mobile phone are executed in a suitable sequence in accordance with the operation of the operation part 12.

Here, as various types of processing of the mobile phone, there can be mentioned audio speech carried out through a line exchange network, preparation and transmission/reception of e-mails, viewing of Internet Web (World Wide Web) sites, and so on. Further, the operation control of blocks explained above are the transmission/reception of signals at the communication part 11, input/output of voice at the voice processing part 13, display of an image in the display part 16, and other control.

The control part 18 is provided with a computer (microprocessor) executing processing based on a program (operating system, application program, etc.) stored in the memory part 17 and runs the processing explained above according to the sequence instructed in this program.

Namely, the control part 18 sequentially reads command codes from the operating system, application program, or other program stored in the memory part 17 to execute the processing.

As portions directly connected with the present first and second embodiments, the control part 18 has a function of sending to the communication part 11 an acquisition instruction instructing acquisition of any of the plurality of communication systems when the start of communication is requested in a state judged “out-of-service-area” in which communication cannot be carried out.

The control part 18 is, as shown in FIG. 4, configured by a key detection part 181, display control part 182, EVDO protocol execution part 183, “1x” protocol execution part 184, communication system selection part 185, acquisition instruction function execution part 186, and timer monitor part 187.

Note that the functions of these blocks are achieved by running a program stored in the memory part 17 at the control part 18. These do not indicate only blocks actually built-in the control part 18 discriminated from other blocks and just express the processing parts separated for simplifying the explanation.

The key detection part 181 has a function of detecting a send operation from the operation part 12 and starting up the acquisition processing by the acquisition instruction function execution part 186.

Further, the display control part 182 has a function of displaying success or failure of a send operation output via the acquisition instruction function execution part 186 in the display part 16.

These key detection part 181 and display control part 182 perform roles as user interfaces.

The EVDO protocol execution part 183 functions as a first protocol execution part instructing the communication part 11 of acquisition by the first communication protocol (EVDO: Evolution Data Only).

Further, the “1x” protocol execution part 184 functions as a second protocol execution part instructing the communication part 11 of acquisition by the second communication protocol (“1x”).

The EVDO protocol execution part 183 and “1x” protocol execution part 184 execute communication with the base station 20.

The communication system selection part 185 has a function of instructing the communication part 11 of the communication system to be acquired.

The communication system selection part 185, concretely, when performing the acquisition processing based on the acquisition processing start instruction generated in the first predetermined time from when the out-of-service-area state was entered, makes the EVDO protocol execution part 183 or “1x” protocol execution part 184 perform the first acquisition processing of performing acquisition by a first routine as will be explained later.

Further, the communication system selection part 185, when performing the acquisition processing based on the acquisition processing start instruction generated exceeding the first predetermined time from when the out-of-service-area state was entered, makes the EVDO protocol execution part 183 or “1x” protocol execution part 184 perform the second acquisition processing of performing the acquisition by a second routine which is different from the previous first routine.

The communication system selection part 185 stores the time when the out-of-service-area state was shifted to by the timer monitoring by the timer monitor part 187 and judges, when making the EVDO protocol execution part 183 or “1x” protocol execution part 184 perform the acquisition processing, whether or not this time exceeds the first predetermined time (for example, 4 seconds) by comparing the time when the start of communication was requested and the stored time when the out-of-service-area state was shifted to.

Note that, the communication system selection part 185, when instructing the EVDO protocol execution part 183 or “1x” protocol execution part 184 of the communication system to be acquired, may refer to a scan list in which communication systems which can be acquired are stored in a predetermined order such as MRU (Most Recently Used) or PRL (Preferred Roaming List) prepared in advance.

The MRU is data in which the order is defined so that the most recently selected communication system is stored at the head position and selected with the highest priority.

Further, the PRL is data where a plurality of communication systems are stored in correspondence to EVDO and “1x” protocol. The order is defined so that, between EVDO and “1x” protocol, EVDO is given a higher priority in the EVDO, priority is given in an order of 2 GHz, new 800 MHz, and present 800 MHz among a plurality of communication systems, and further a primary channel is selected with a higher priority than a secondary channel.

In the scan list referred to here, a storage region thereof is secured in the memory part 17 when turning on a power supply, and the data is written one after another whenever an acquisition attempt (system scan) is carried out.

Further, the difference between the “first acquisition processing of performing acquisition by the first routine” and the “second acquisition processing of performing acquisition by the second routine” referred to here means, for example, the difference of the number of times of acquisition attempts of the communication systems or the order of acquisition attempts of the communication systems. These differences have an influence upon the consumption of the battery when driving a mobile phone.

The acquisition instruction function execution part 186 has a function of sending to the communication system selection part 185 an acquisition processing start instruction of the communication system.

The acquisition instruction function execution part 186, concretely, when the start of communication is requested in a state judged “out-of-service-area” in which communication cannot be carried out, sends to the communication system selection part 185 an acquisition processing start instruction instructing acquisition of any of the plurality of communication systems. Then, the acquisition instruction function execution part 186, when an acquisition success is informed for that acquisition processing start instruction, performs processing of the start of communication by the successfully acquired communication system.

The acquisition instruction function execution part 186 further sends a new acquisition processing start instruction to the communication system selection part 185 when an acquisition failure is informed from the communication system selection part 185 for that acquisition processing start instruction after sending the acquisition processing start instruction. Then, the acquisition instruction function execution part 186 sends a new acquisition processing start instruction (re-try) to the communication system selection part 185 when the success of acquisition is not informed from the communication system selection part 185 for that acquisition processing start instruction and the second predetermined time (for example, 4 seconds) passes.

Note that, the fact that the first predetermined time and second predetermined time described above have passed is judged according to a time-out signal output from the timer monitor part 187.

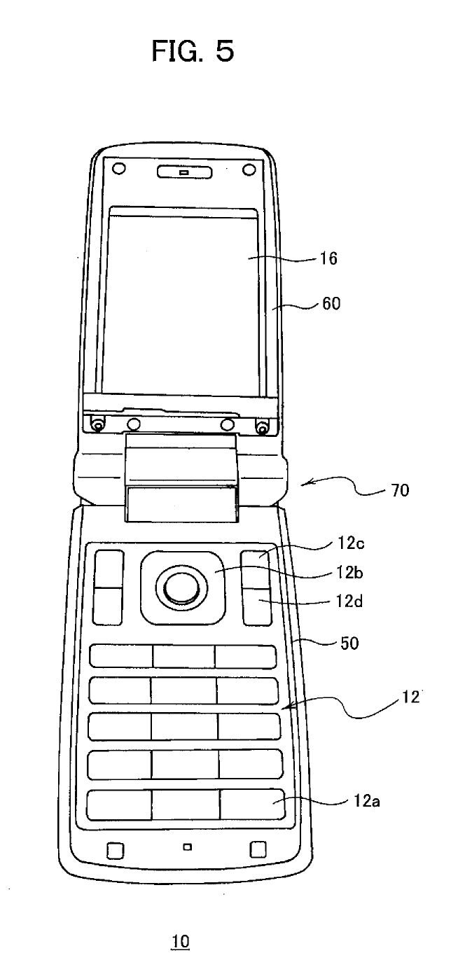

FIG. 5 is a perspective view showing an example of the configuration of the outer appearance of a mobile phone used as a wireless communication terminal according to an embodiment of the present invention. FIG. 5 mainly shows the array of keys.

As shown in FIG. 5, a wireless terminal device 10 is configured as a so-called flip-open type mobile phone and is provided with a sender case 50 and a receiver case 60 which are connected to each other pivotably between an open state and a closed state.

The sender case 50 and the receiver case 60 form a housing of the wireless communication terminal as a whole by connection of end portions by a connection part 70 serving as the center axis of relative opening and closing operations.

The sender case 50 is provided with an operation input part 12 in which various types of keys are arranged exposed at the front surface. Further, the receiver case 60 is provided with a display part 16.

In the operation input part 12 of the sender case 50, as various types of keys, for example, a tenkey part 12a, a cursor key 12b, function keys 12c, etc. are arranged.

The keys of the tenkey part 12a described above are assigned pluralities of characters such as Sino-Japanese ideographs, alphanumerics, phonetic kana marks, and symbols.

The effective characters intended by the tenkey part 12a are switched by a toggle operation by an “input mode change key (identification key)” assigned to any of the function keys 12c.

Any of these keys, for example, a function key 12c, is assigned as the operation key for sending a send instruction etc.

Note that, this operation key may be assigned to a not shown side key as well which is arranged on a side surface of the sender case.

Next, the operation of the wireless communication terminal 10A of FIG. 4 will be explained as the first embodiment and second embodiment.

### First Embodiment

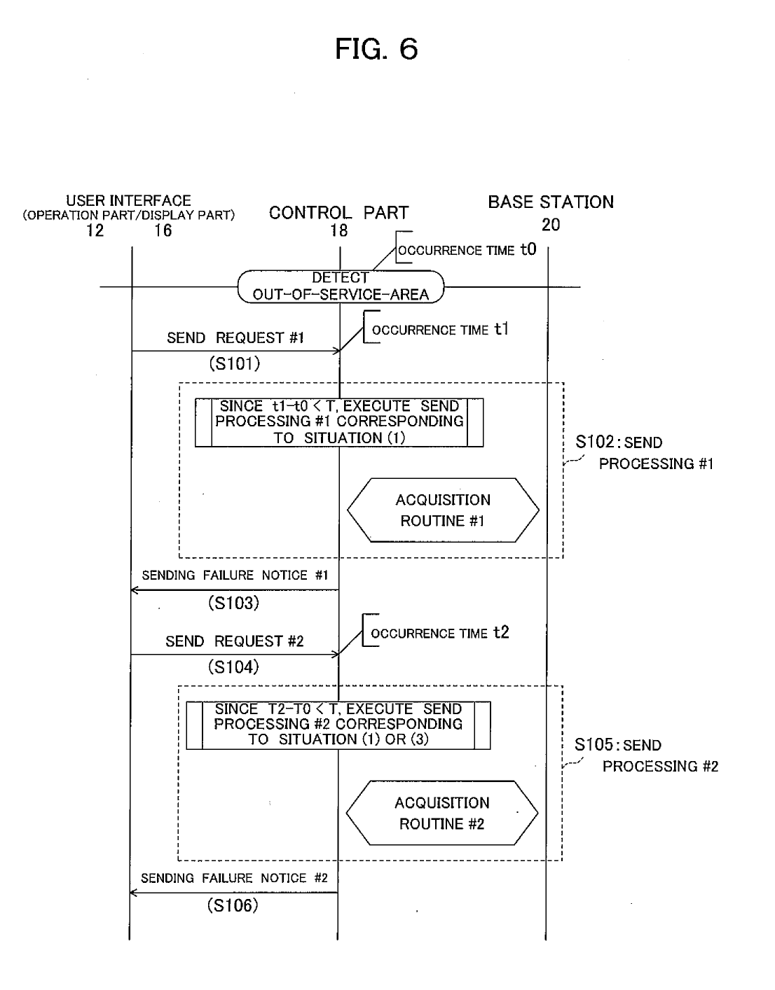

FIG. 6 is an operation sequence diagram cited for explaining the operation of the wireless communication terminal according to the first embodiment of the present invention.

FIG. 6 shows an operation sequence among the user interface configured by the operation part 12 and the display part 16, the control part 18, and the base station 20.

Below, the operation of the wireless communication terminal 10A according to the first embodiment of the present invention will be simply explained with reference to the operation sequence of FIG. 6.

In FIG. 6, the control part 18, when detecting the out-of-service-area state in which the mobile phone cannot perform communication, stores an occurrence time t0 thereof in a built-in memory (not shown).

Subsequently, the control part 18, when a send request #1 is generated by, for example, a user operating the operation part 12 (depressing the send key etc.) (S101), further stores an occurrence time t1 thereof in the built-in memory.

By this, the control part 18 calculates a difference (t1−t0) from the previously stored “out-of-service-area” state occurrence time t0 and compares this with the predetermined time (threshold value T) defined in advance.

Note that, the threshold value T set here is determined according to a mean out-of-service-area stay time in an actual commercial network. Four seconds are assumed here.

As a result of the comparison described above, here, assume a judgment as t1−t0≦T. For this reason, the control part 18 judges that the mobile phone is in the situation (1) shown in FIG. 2 and executes the system scan according to the first acquisition routine between this and the base station 20. Here, the processing from the comparison with the threshold value T described above to the execution of the system scan is shown as the send processing #1 (S102).

When the acquisition of the communication system fails as the result of the system scan based on the send processing #1, the control part 18 displays a message showing an acquisition failure via the user interface (display part 16) (S103).

Next, in the out-of-service-area state, when a send request #2 is generated by the user operating the operation part 12 of the wireless communication terminal 10 used as a mobile phone (S104), the control part 18 stores the occurrence time t2 thereof in the built-in memory again.

Subsequently, the control part 18 calculates a difference (t2−t0) from the previously stored “out-of-service-area” state occurrence time t0 and compares this with the previously defined threshold value T.

As a result of the comparison, here, assume a judgment as t2−t0>T. For this reason, the control part 18 judges that the mobile phone is in the situation (2) or (3) shown in FIG. 2 and executes the system scan according to the second acquisition routine between this and the base station 20. Here, the processing from the comparison with the threshold value T described above to the execution of the system scan is shown as the send processing #2 (S105).

Note that, here, the second acquisition routine means an execution schedule of the system scan suppressing the consumption of the battery of the mobile phone in comparison with the first acquisition routine, for example, decreasing the number of communication systems to be acquired.

As the result of the system scan based on the send processing #2 described above, when failing in the acquisition of the communication system, the control part 18 displays a message showing an acquisition failure via the user interface (display part 16) (S106).

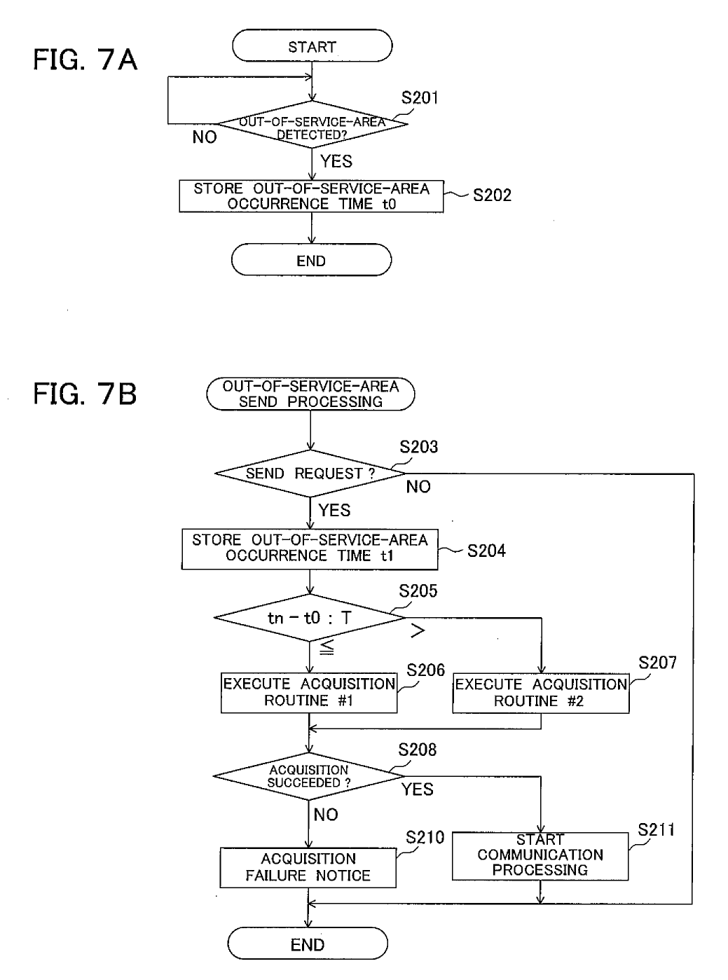

FIG. 7A and FIG. 7B are flow charts showing concrete routines of the “out-of-service-area” send processing of the control part 18 described above.

Below, the operation of the wireless communication terminal 10A of FIG. 4 according to the first embodiment of the invention will be explained in detail with reference to the flow charts of FIG. 7A and FIG. 7B.

The acquisition instruction function execution part 186, when detecting the out-of-service-area state in which communication cannot be carried out by the mobile phone first (S201 of FIG. 7A), refers to the output of the timer monitor part 187 and stores the “out-of-service-area” state occurrence time t0 in the built-in memory (S202).

In the out-of-service-area state described above, for example, when the send request #1 is generated and output by, for example, the user operating (depressing the send key etc.) of the operation part 12 of the mobile phone (S203 “Yes” of FIG. 7B), the acquisition instruction function execution part 186 refers to the output of the timer monitor part 187, stores the send request generation time t1 in the built-in memory (S204), calculates a difference (t1−t0) from the previously stored “out-of-service-area” state occurrence time t0, and compares this with the previously set time threshold value T (S205).

When it is judged as t1−t0≦T as the result of the comparison, the communication system selection part 185 judges that the mobile phone is in the situation (1) shown in FIG. 2 and instructs the EVDO protocol execution part 183 or “1x” protocol execution part 184 of execution of the system scan according to the acquisition routine #1 as the first acquisition routine (S206). On the other hand, when it is judged as (t1−t0)>T, the communication system selection part 185 judges that the mobile phone is in the situation (2) or (3) shown in FIG. 2 and instructs the EVDO protocol execution part 183 or “1x” protocol execution part 184 of execution of the system scan according to the acquisition routine #2 as the second acquisition routine by which the execution suppressing the consumption of the battery in comparison with the acquisition routine #1 is possible (S207).

The EVDO protocol execution part 183 or “1x” protocol execution part 184 receiving this executes the system scan by the selected communication system one after another according to the acquisition routine #1 or acquisition routine #2 between this and the base station 20 and informs the result to the communication system selection part 185 every time.

Note that it is assumed that the out-of-service-area state does not change at this point of time, therefore the system scan for the send request #1 fails (S208 “No”), and the EVDO protocol execution part 183 or “1x” protocol execution part 184 informs the acquisition failure to the communication system selection part 185 (S210).

The communication system selection part 185 further informs the acquisition failure to the acquisition instruction function execution part 186 (S210). However, when the acquisition succeeds (S208 “Yes”), the selection part starts communication processing by the successfully acquired communication system with the base station 20 (S211).

Note that, the system may also be configured so that, at steps S206 and S207, when an acquisition succeeds during the acquisition attempt, the processing immediately advances to step S208 even if all acquisition attempts are not completed.

On the other hand, in the processing of S210, the acquisition instruction function execution part 186 displays a message showing an acquisition failure via the user interface (display part 16).

According to the first embodiment of the present invention described above, there can be provided a wireless communication terminal capable of suppressing the battery consumption while improving user friendliness by defining the period immediately after the shift to “out-of-service-area” to a certain time T as the situation of (1) by the send request based on the user operation, enabling an approximation of a period from the certain time T to the in-area reset as the situation (2) or situation (3), and changing a content of the send processing based on this situation judgment (first acquisition routine and second acquisition routine).

Here, “user friendliness” means the sending success rate and provision of opportunities for send operations to the user.

### Second Embodiment

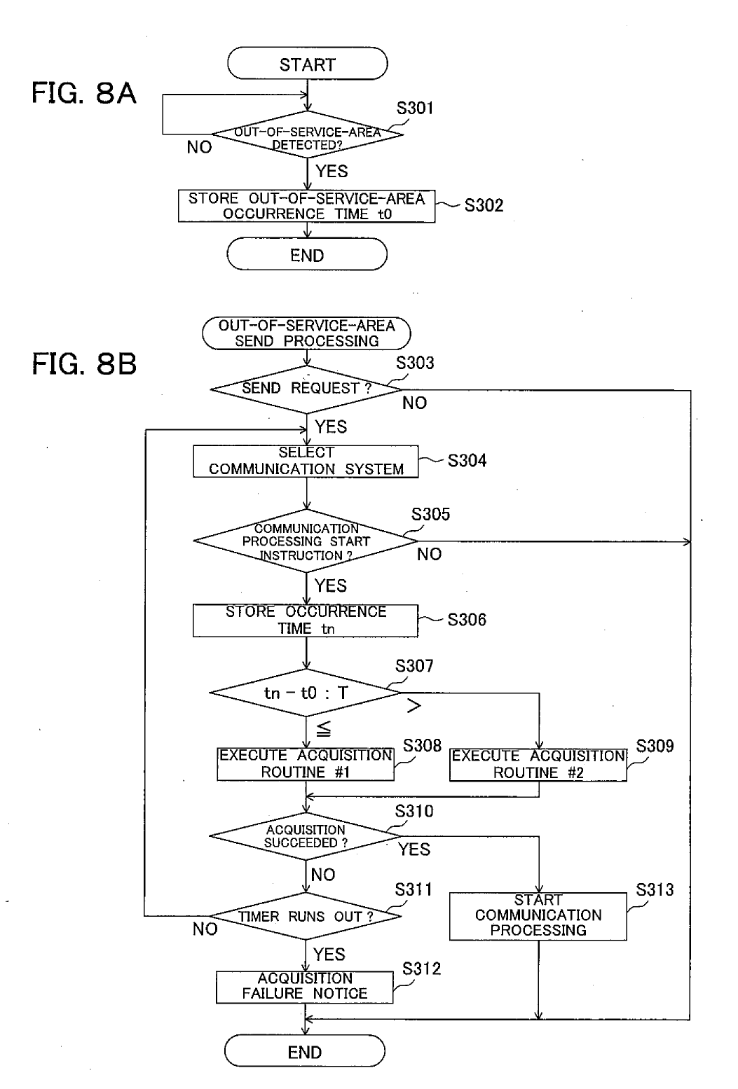

FIG. 8A and FIG. 8B are flow charts cited for explaining the operation of the wireless communication terminal according to the second embodiment of the present invention.

The difference of the present second embodiment from the first embodiment explained with reference to FIG. 7A and FIG. 7B resides in that, in contrast to the first embodiment explained above triggering the “out-of-service-area” send processing by a send request by the user operation, the present second embodiment triggers it by the acquisition start instruction output from the acquisition instruction function execution part 186 to the communication system selection part 185.

Below, the operation of the wireless communication terminal according to the present second embodiment will be simply explained with reference to the flow charts of FIG. 8A and FIG. 8B.

The acquisition instruction function execution part 186, when detecting the out-of-service-area state in which communication cannot be carried out by the mobile phone first (S301 of FIG. 8A), refers to the output of the timer monitor part 187 and stores the “out-of-service-area” state occurrence time t0 (S302).

In the out-of-service-area state described above, for example, when the send request is made by, for example, the user operating of the operation part 12 of the mobile phone (depressing the send key etc.) (S303 “Yes” of FIG. 5B), the acquisition instruction function execution part 186 outputs the acquisition processing start instruction instructing the execution of the system scan for acquiring any of the plurality of communication systems to the communication system selection part 185.

The communication system selection part 185 receiving the acquisition processing start instruction selects a communication system (S304) and instructs the EVDO protocol execution part 183 or “1x” protocol execution part 184 of execution of the system scan so as to perform an acquisition attempt of the selected communication system.

At this time (S305 “Yes”), the communication system selection part 185 refers to the output of the timer monitor part 187 and stores a send request generation time t3 in the built-in memory (S306). Further, the communication system selection part 185 refers to the “out-of-service-area” state occurrence time to previously stored by the acquisition instruction function execution part 186, calculates a difference (t3−t0) from that timer and compares this with the previously defined time threshold value T (S307).

When it is judged as (t3−t0)≦T as the result of the comparison, the communication system selection part 185 judges that the mobile phone is in the situation (1) shown in FIG. 2 and instructs the EVDO protocol execution part 183 or “1x” protocol execution part 184 of execution of the system scan according to the acquisition routine #1 (S308).

On the other hand, when it is judged as (t3−t0)>T, the communication system selection part 185 judges that the mobile phone is in the situation (2) or (3) shown in FIG. 2 and instructs the EVDO protocol execution part 183 or “1x” protocol execution part 184 of execution of the system scan according to the acquisition routine #2 which can be executed while suppressing the consumption of the battery in comparison with the acquisition routine #1 (S309).

The EVDO protocol execution part 183 or “1x” protocol execution part 184 receiving this executes the system scan by the selected communication system one after another according to the acquisition routine #1 or acquisition routine #2 with the base station 20 and informs the result to the communication system selection part 185 every time.

Note that it is assumed that the out-of-service-area state does not change at this point of time, therefore the acquisition of the communication system for the above system scan instruction ends in failure, and the EVDO protocol execution part 183 or “1x” protocol execution part 184 informs the acquisition failure to the communication system selection part 185.

The communication system selection part 185 further informs the acquisition failure to the acquisition instruction function execution part 186. The acquisition instruction function execution part 186 is monitoring the timer concerning the elapsed time from the start of the “out-of-service-area” processing and, when a time-out state (Tmax as the third time for giving up the “out-of-service-area” send processing) is not detected from the timer monitor part 187 (S311 “No”), outputs a new acquisition processing start instruction to the communication system selection part 185.

The communication system selection part 185 receiving this repeatedly executes the processing of S304 and on for instructing the EVDO protocol execution part 183 or “1x” protocol execution part 184 of execution of the system scan according to the acquisition routine #1 or acquisition routine #2.

Here, when a new acquisition processing start instruction is issued (S305 “Yes”), the communication system selection part 185 selects a communication system (S304) and instructs the EVDO protocol execution part 183 or “1x” protocol execution part 184 of execution of the system scan so as to perform an acquisition attempt of the selected communication system. At this time (S305 “Yes”), the communication system selection part 185 refers to the output of the timer monitor part 187 and stores the occurrence time tn thereof in the built-in memory again (S306).

Subsequently, the communication system selection part 165 calculates a difference (tn−t0) from the previously stored “out-of-service-area” state occurrence time t0 and compares this with the previously defined threshold value T (S307). As the result of comparison, when it is judged as (tn−t0)>T, the communication system selection part 185 judges that the mobile phone is in the situation (2) or (3) shown in FIG. 2 and executes the system scan according to the acquisition routine #2 with the base station 20 (S309).

On the other hand, at S310, when the acquisition succeeds (S310 “Yes”), the selection part starts the communication processing by that successfully acquired communication system with the base station 20 (S313). Note that, the system may also be configured so that, at steps S308 and S309, if the acquisition succeeds during the acquisition attempt, the processing is immediately advanced to step S313 even if all acquisition attempts are not completed.

Further, when time-out state of the Tmax time is detected in the processing of S311 (S311 “Yes”), the acquisition instruction function execution part 186 displays a message showing an acquisition failure via the user interface (display part 16) (S312).

Note that, although not shown in the flow charts of FIG. 8A and FIG. 8B, it is assumed that the acquisition instruction function execution part 186 issues a new acquisition processing start instruction (re-tries) to the communication system selection part 85 even if success or failure is not informed from the communication system selection part 185 for this acquisition processing start instruction after outputting the acquisition processing start instruction to the communication system selection part 185 and the second predetermined time (for example, 4 seconds) has passed.

Due to this, whenever a re-try occurs, the elapsed time is judged from the time at the shift to “out-of-service-area”, therefore an acquisition attempt according to the acquisition routine adapted to the signal situation around the wireless communication terminal which changes every moment is possible, so the possibility of succeeding earlier becomes high.

According to the second embodiment described above, there can be provided a wireless communication terminal capable of suppressing the battery consumption while improving user friendliness by defining, based on the acquisition processing start instruction generated by the control part 18 (acquisition instruction function execution part 186), the period immediately after the shift to “out-of-service-area” to a certain time T as the situation of (1) and enabling an approximation of a period from the certain time T to the in-area reset to the situation (2) or situation (3) and changing the content of the send processing based on this situation judgment (first acquisition routine and second acquisition routine)

Note that, according to the first embodiment and second embodiment explained above, the control part 18 (communication system selection part 185) executed the first acquisition routine and second acquisition routine by switching according to the elapsed time after the shift to the “out-of-service-area” state. However, a plurality of scan lists (reference destinations) in which communication systems which can be acquired by a wireless communication terminal are stored in different orders such as MRU and PRL may be provided, and reference destinations may be switched according to the elapsed time after the shift to the out-of-service-area state to make the EVDO protocol execution part 183 or “1x” protocol execution part 184 execute the system scan.

At this time, MRU, PRL, or another scan list is assigned to and stored in the memory part 17. Further, the time T was fixed in the embodiments described above, but another configuration of making this variable or providing two or more types of times T so that the acquisition routine is selected from among three or more types for each elapsed time is possible. Further, joint use may be made of a timer changing an intermittent interval of the intermittently repeated in-area reset processing.

### Third Embodiment

Next, a third embodiment will be explained.

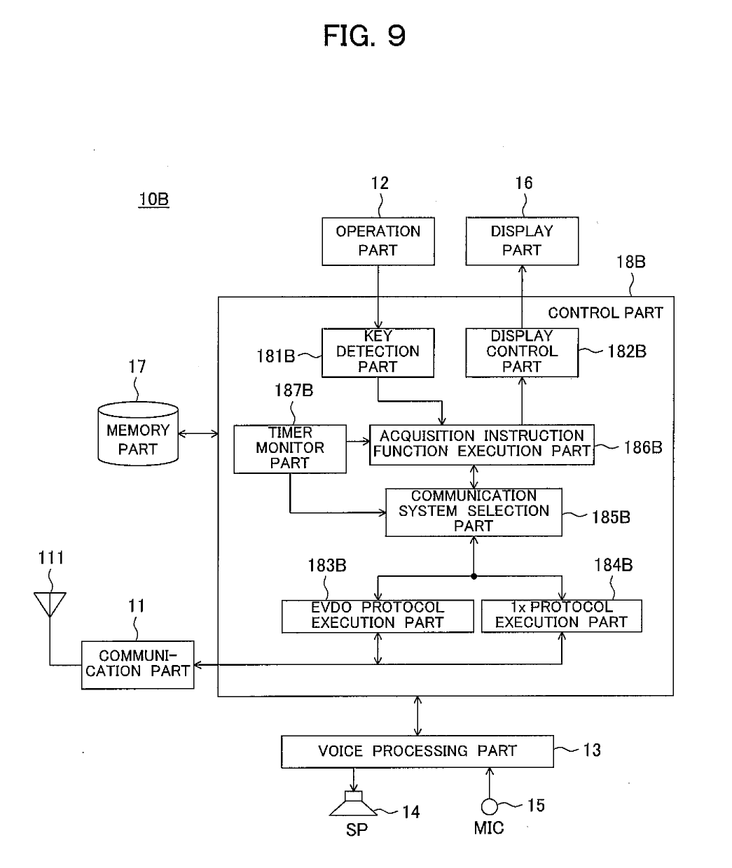

FIG. 9 is a block diagram showing an example of the configuration of a signal processing system of a wireless communication terminal according to the third embodiment of the present invention.

A wireless communication terminal 10B according to the present third embodiment and the wireless communication terminal 10A according to the first and second embodiments explained above are the same in the basic configurations, but differ in control operations of the control parts.

Namely, in the wireless communication terminal 10B according to the third embodiment, a control part 18B executes the acquisition attempt processing for n number of communication systems when an elapsed time from the shift to the out-of-service-area state to the generation of the communication start request is a first time. Further, the control part 18B controls the communication part to execute the acquisition attempt processing for m (where m>n) number of communication systems when it is a second time shorter than the first time.

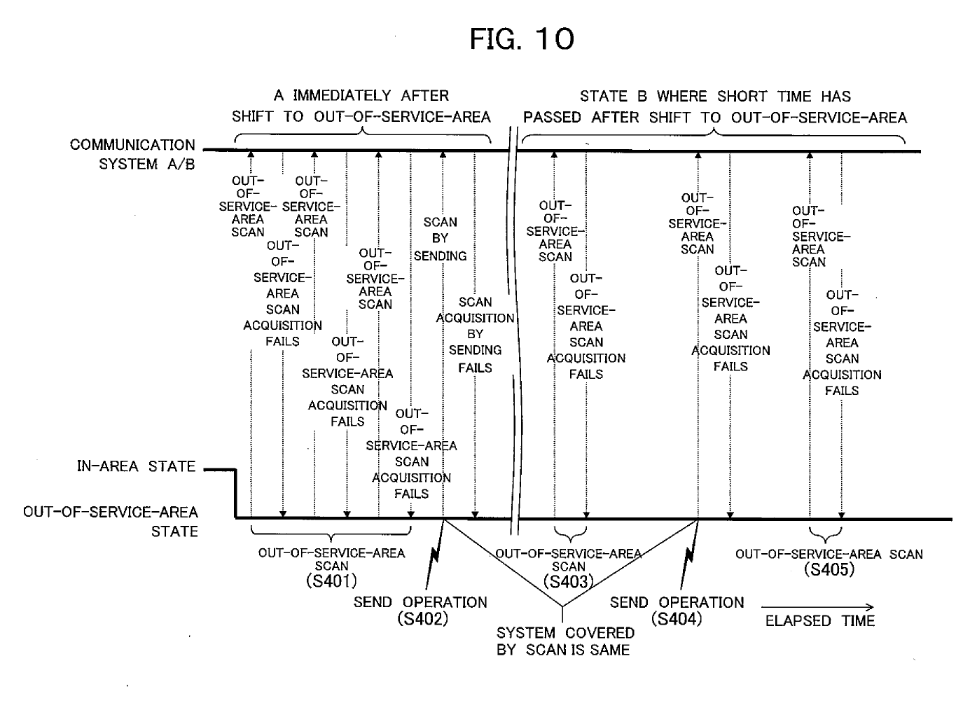

Here, first, an out-of-service-area send operation (1) of the multiband wireless communication terminal having 11 patterns of communication systems explained before will be explained with reference to the operation sequence shown in FIG. 10. After that, the configuration and function of the wireless communication terminal 10B in the present third embodiment will be explained.

The wireless communication terminal basically has the feature that it tries to maintain the in-area state. Namely, the wireless communication terminal is provided with a scan list in which communication (acquisition) enabled communication systems are stored.

The wireless communication terminal, when the out-of-service-area state is exhibited, outputs an acquisition instruction from the communication system stored at the head position of the scan list unless the send operation is carried out. After that, the wireless communication terminal repeatedly executes the acquisition attempt processing (hereinafter referred to as the out-of-service-area scan) of the communication system for the in-area reset by a predetermined cycle until the acquisition of the listed communication system succeeds (S401).

Here, when an elapsed time from the shift to out-of-service-area is long, for saving power, processing for decreasing the number of the in-area reset processing is executed as well.

On the other hand, during execution of processing of periodically performing the above out-of-service-area scan in the background, the wireless communication terminal detects a send request generated by the user performing the send operation or a send request from the application (S402).

The wireless communication terminal, when detecting the send request, shifts to the out-of-service-area send processing and outputs the acquisition instruction from the communication system stored at the head position of the scan list again. After that, the wireless communication terminal starts the acquisition attempt processing of communication systems stored in the scan list until the acquisition of the communication system succeeds.

Concretely, the wireless communication terminal, when detecting the out-of-service-area send request, obtains a communication system A stored at the head position of the scan list as a scan candidate and performs the system scan of the communication system A first.

Then, the wireless communication terminal, when the acquisition of that communication system A fails, obtains a communication system B stored at the second position of the scan list next and performs the system scan of this communication system B.

The scan of the communication system described above is repeatedly executed for exactly a predetermined time set in a re-try timer. When a time-out state is detected, the acquisition attempt processing of the communication system is started again, and the system scan described above is repeatedly executed.

The above acquisition attempt processing of the communication systems automatically ends sending when it cannot communicate with the base station even if the send operation is continued for, for example, 40 seconds.

According to the out-of-service-area send operation (1) described above, the communication system to be acquired is the same in both of a case A immediately after the shift to the out-of-service-area state and a case B where some time has passed after the shift to out-of-service-area state. Immediately after the shift to out-of-service-area state, the acquisition attempt processing by the out-of-service-area scan is carried out for every constant time. In the out-of-service-area scan, the technique of the so-called “Tomarigi Search” is used.

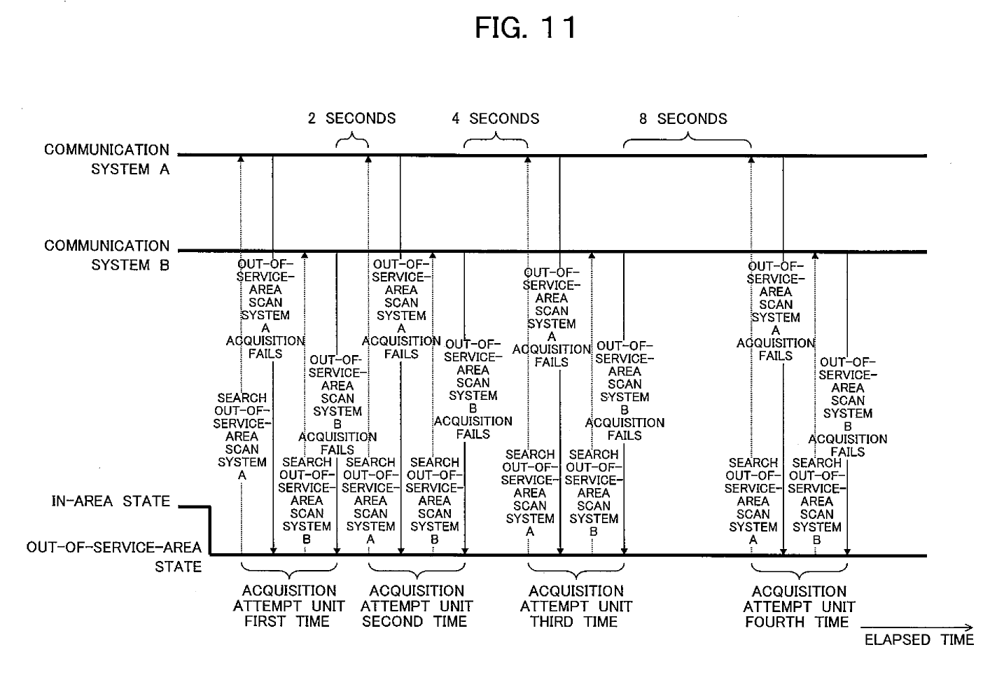

FIG. 11 is a diagram for explaining a basic technique of “Tomarigi (perch) Search” and shows an example of the operation sequence of the in-area reset processing on a time axis.

As apparent from FIG. 11, the wireless communication terminal executes the in-area reset processing (out-of-service-area scan) for acquiring a communication system again after shifting to the out-of-service-area state. However, this out-of-service-area scan is a so-called “Tomarigi Search” in which the acquisition attempt operation is carried out again for the communication systems A and B at a relatively short interval immediately after shifting to the out-of-service-area state and the interval of the acquisition attempt operation is extended along with the elapse of time (1st to 4th times) (2 seconds→4 seconds→8 seconds).

Note that, in FIG. 11, the acquisition attempt unit means a sequence in which the out-of-service-area scan of the communication system A is carried out, a notice of acquisition success or failure is received, the out-of-service-area scan of the communication system B is carried out, and a notice of acquisition success or failure is received.

Return to the operation sequence of FIG. 10. The “Tomarigi Search” is the state where a so-called “out-of-service-area” state is frequently confirmed since the acquisition attempt processing is repeated at a relatively short interval immediately after the shift to the out-of-service-area state. Therefore, the wireless communication terminal is considered to stay stable out-of-service-area because of impossibility of acquisition of a communication system here.

Further, when compared with a case where some time has passed after the shift to the out-of-service-area state, the interval of the acquisition attempt processing of the communication system in the out-of-service-area scan is longer in comparison with that immediately after the shift to the out-of-service-area state. Therefore, this may be a state where the possibility of the in-area reset is not confirmed for a while as well. It is hard to believe that it is stabler out-of-service-area in comparison with immediately after the shift to the out-of-service-area state. Namely, actually the surrounding signal environment has reset to an in-area area, but recognition of reset to the in-area area is slow in comparison with immediately after the shift to the out-of-service-area state since the interval of the scan is long.

From this fact, the possibility is high that the acquisition attempt processing due to an out-of-service-area send operation immediately after the shift to the out-of-service-area state will only result in re-confirmation (acquisition failure) of a communication system for which the acquisition failed recently, therefore the number of useless acquisition attempt processings is liable to increases. Further, useless acquisition attempt processings of the communication system exert an influence upon the consumed current as well, so longer battery life is liable to be hindered.

For this reason, in an out-of-service-area send operation (2) explained later, the communication system covered by the out-of-service-area send processing immediately after the shift to the out-of-service-area state is determined based on the elapsed time after the shift to the out-of-service-area state (out-of-service-area stay time) and the communication systems covered by the acquisition attempt processing by the out-of-service-area send operation are increased as the out-of-service-area stay time becomes longer. Due to this, suppression of battery consumption is achieved while securing opportunities for send operations.

Next, the configuration and function of the wireless communication terminal 10B in the present third embodiment will be explained.

As explained before, the wireless communication terminal 10B according to the present third embodiment and the wireless communication terminal 10A according to the first and second embodiments are the same in basic configurations, therefore the explanation will be given focusing on the different portions.

As portions related to the present third embodiment, the communication part 11 has a function of monitoring the time when starting the acquisition attempt processing from when the “out-of-service-area” state is judged under the control by the control part 18B, executing the acquisition attempt processing based on n number of communication systems when the elapsed time from when the out-of-service-area state was shifted to is the first time, and executing the acquisition attempt processing based on m (where n>m) number of communication systems when it is the second time. Details will be explained later.

In the present third embodiment, the control part 18B has a function of sending the acquisition instruction to the communication part 11 for instructing the acquisition of any of the plurality of communication systems when the start of communication is requested in a state judged as an “out-of-service-area” state in which communication cannot be carried out.

The control part 18B is, in the same way as the case of the first and second embodiments, configured by a key detection part 181B, display control part 182B, EVDO protocol execution part 183B, “1x” protocol execution part 184B, communication system selection part 185B, acquisition instruction function execution part 186B, and timer monitor part 187B.

Note that the functions of these blocks are achieved by running a program stored in the memory part 17 at the control part 18B. These do not indicate only blocks actually built-in the control part 18B discriminated from other blocks and just express the processing parts separated for simplifying the explanation.

The key detection part 181B has a function of detecting a send operation from the operation part 12 and starting up the acquisition processing by the acquisition instruction function execution part 186B.

Further, the display control part 182B has a function of displaying success/failure of the send operation output via the acquisition instruction function execution part 186B in the display part 16.

These key detection part 181B and display control part 182B perform roles as user interfaces.

The EVDO protocol execution part 183B functions as the first protocol execution part instructing the communication part 1 of acquisition by the first communication protocol (EVDO), and the “1x” protocol execution part 184B functions as a second protocol execution part instructing the communication part 1 of acquisition by the second communication protocol (“1x”), and are engaged in communication with the base station 20.

The communication system selection part 185B has a function of instructing the communication part 11 of the communication system to be acquired.

The communication system selection part 185B, concretely, sets the time duration for which the acquisition attempt processing is continued in accordance with the elapsed time from when an “out-of-service-area” state is judged to when the acquisition attempt processing is started when the acquisition processing start instruction is made from the acquisition instruction function execution part 186B and that acquisition attempt processing is performed and executes the acquisition attempt processing for this time duration.

Concretely, the communication system selection part 185B makes the EVDO protocol execution part 183B or “1x” protocol execution part 184B perform the acquisition attempt processing with the base station 20.

The communication system selection part 185B further monitors the time with reference to the timer monitor part 187B when the acquisition attempt processing start instruction is made from the acquisition instruction function execution part 186B and that acquisition attempt processing is carried out. The communication system selection part 185B executes the acquisition attempt processing for n number of communication systems when the elapsed time after shift to the out-of-service-area state is the first time and executes the acquisition attempt processing for m (where n>m) number of communication systems when it is the second time.

Namely, the communication system selection part 185B instructs the EVDO protocol execution part 183B or “1x” protocol execution part 184B of execution of the acquisition attempt processing by a larger number of communication systems when the elapsed time after the shift to the out-of-service-area state is long and instructs the part 183 or the part 184B of execution of the acquisition attempt processing by a relatively small number of communication systems when the elapsed time is short.

The acquisition instruction function execution part 186B has a function of instructing the communication system selection part 185B to start the acquisition attempt processing of the communication system.

The acquisition instruction function execution part 186B, concretely, when the start of communication is requested in a state judged as “out-of-service-area” in which communication cannot be carried out, sends to the communication system selection part 185B the acquisition attempt processing start instruction instructing acquisition of any of the plurality of communication systems. The acquisition instruction function execution part 186B, when the predetermined time has passed (re-try timer runs out of time) before an acquisition success is informed for that acquisition attempt processing start instruction, instructs the communication system selection part 185B again to start the acquisition attempt processing (re-try).

Further, the acquisition instruction function execution part 186B performs processing of the start of communication by the successfully acquired communication system when an acquisition success is informed for the acquisition attempt processing start instruction.

The timer monitor part 187B is controlled by the acquisition instruction function execution part 186B, an elapsed time timer counting the out-of-service-area stay time is prepared other than the re-try timer described above, and monitoring of time is carried out in each.

Accordingly, when the out-of-service-area state in which communication cannot be carried out is shifted to, the timer monitor part 187B is activated by the acquisition instruction function execution part 186B, and counting by the timer is started. Note that, the timer is reset to “0” when the wireless communication terminal shifts to in-area.

Note that, here, the out-of-service-area state means a state where acquisition of communication system is not possible by either the EVDO protocol execution part 183B or “1x” protocol execution part 184B, a state where the out-of-service-area flag is set ON and the display part 16 displays “out-of-service-area” by the acquisition instruction function execution part 186B, and a state where the in-area reset processing by the communication part 11 is executed.

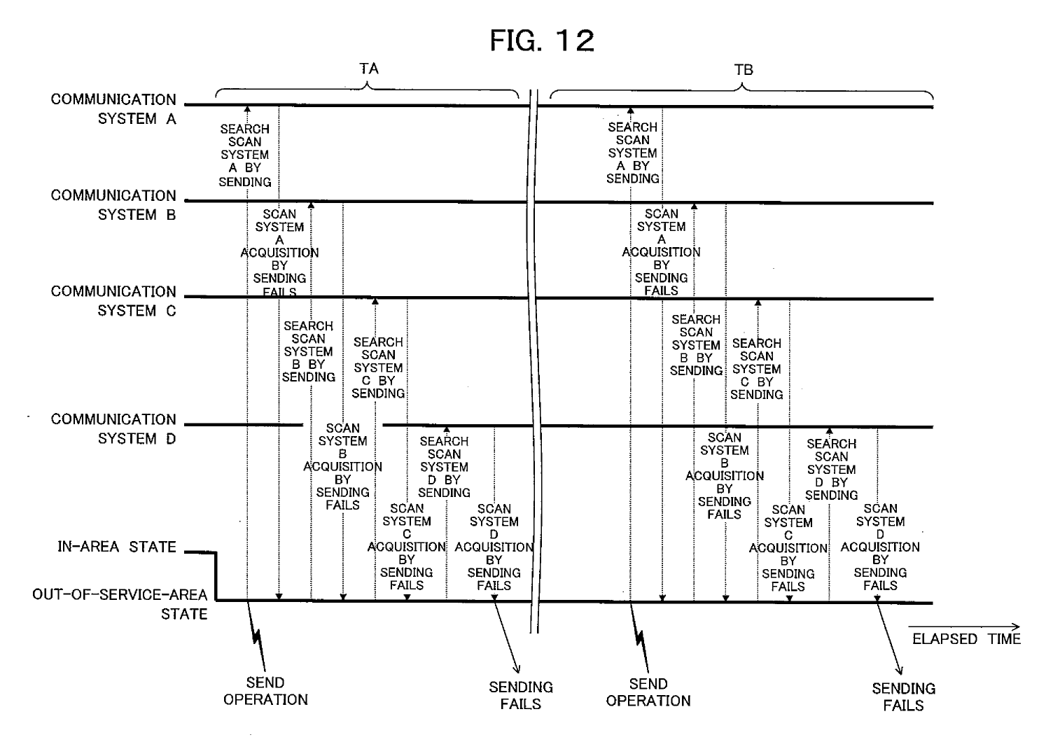

Below, a detailed explanation will be given of the out-of-service-area send operation (2) of the wireless communication terminal 10B according to the present third embodiment with reference to the operation sequence shown in FIG. 12.

First, a send request is generated by the user operating the send key via the operation part 12 or a send request is generated from the application of the wireless communication terminal. At this time, it is judged whether or not the out-of-service-area flag is ON. By this, the wireless communication terminal 10B judges whether or not the terminal is in the in-area state or the out-of-service-area state at present. When judging that the terminal is out-of-service-area, the terminal instructs the acquisition attempt processing of the communication system based on the out-of-service-area send operation and monitors the elapsed time from when the out-of-service-area state is shifted to.

Then, the wireless communication terminal 10B determines the communication system which is covered by the acquisition attempt processing of the communication system by the out-of-service-area send operation based on the out-of-service-area stay time counted by the timer.

The acquisition attempt processing referred to here means processing of receiving the out-of-service-area send request, executing the system scan by communication systems A, B, C, and D by the wireless communication terminal with the base station 20, and outputting success/failure of acquisition.

Note that, in FIG. 12, a period TA shows the time immediately after the shift to out-of-service-area state and shows a stable out-of-service-area state where the interval of the Tomarigi Search is short.

A period TB shows a period for which a relatively long time has passed after the shift to the out-of-service-area state and the interval of “Tomarigi Search” becomes long for saving power in comparison with immediately after the shift to the out-of-service-area state and for which a possibility of the shift to in-area by the acquisition attempt processing by the out-of-service-area send operation is high.

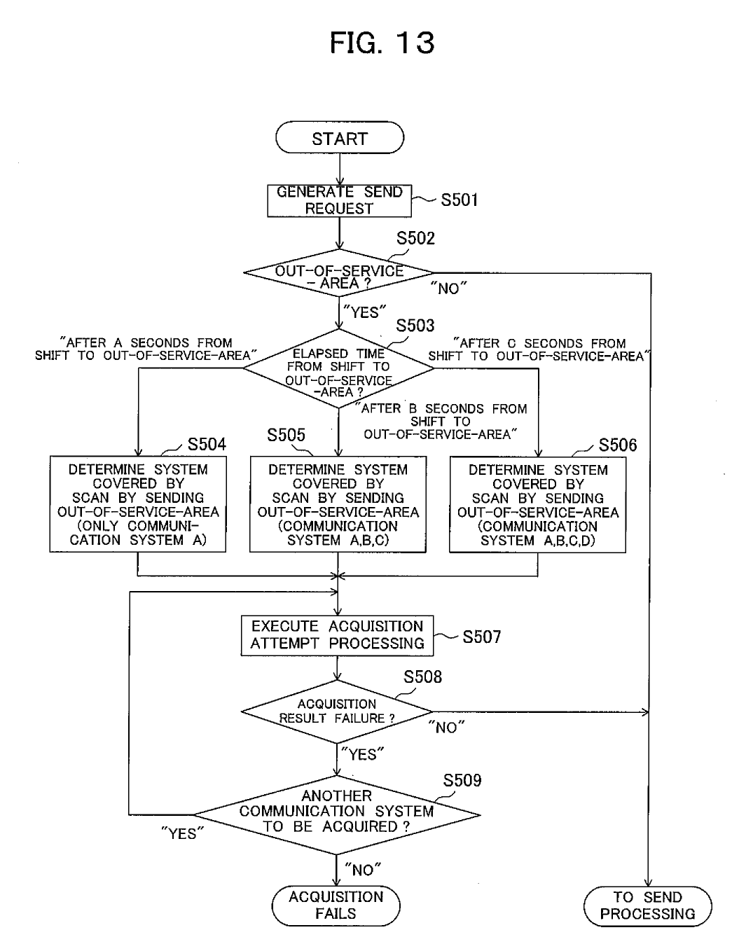

FIG. 13 is a flow chart showing a flow of processing of the acquisition attempt of the wireless communication terminal based on the out-of-service-area send operation according to the third embodiment.

As shown in FIG. 13, the acquisition instruction function execution part 186B judges whether or not the wireless communication terminal is in the out-of-service-area state (S502) when the out-of-service-area send request described above is received (S501 “Yes”). The acquisition instruction function execution part 186B performs usual in-area send processing when judging that it is in-area (S502 “Yes”).

On the other hand, the acquisition instruction function execution part 186B, when judging that the terminal is out-of-service-area (S502 “No”), instructs the communication system selection part 185B to start the acquisition attempt processing of the communication system for the out-of-service-area send operation.

The communication system selection part 185B receiving this acquisition attempt processing start instruction refers to the timer counting the elapsed time from the shift to the out-of-service-area state (out-of-service-area stay time) via the timer monitor part 187B (S503) and determines the communication systems to be covered by acquisition attempt processing determined in accordance with the out-of-service-area stay times A, B, and C (where A<B<C).

Here, a communication system a is determined in a case of an out-of-service-area stay time A, communication systems a and b are determined in a case of an out-of-service-area stay time B, and communication systems a, b, and c are determined in a case of an out-of-service-area stay time C. These are, for example, set in the scan list (S504, S505, S506). Note that, the scan list is assigned to and stored in the predetermined region of the memory part 17.

Note that, the communication system selection part 185B controls the system so as to select n number of communication systems (for example, communication system a) when the elapsed time from when it shifted to the out-of-service-area state to when the send request (communication start request) is generated is the first time (for example, in a time limit A shown in FIG. 12) and select m (where m>n) number of communication systems (for example, communication systems a, b, and c) when it is the second time (for example, in a time limit B shown in FIG. 12).

Namely, the communication system selection part 185B instructs the EVDO protocol execution part 183B or “1x” protocol execution part 184B of execution of the acquisition attempt processing by a larger number of communication systems when the elapsed time from when the out-of-service-area state is shifted to is long and instructs the part 183B or the part 184B of execution of the acquisition attempt processing by a relatively small number of communication systems when the elapsed time is short.

In the setting of the communication systems described above, the in-area reset processing is frequently executed immediately after shift to the out-of-service-area state, but the timing of executing the communication system acquisition attempt processing for the in-area reset processing is set longer along with the elapse of time for saving the power.

Based on this (Tomarigi Search), immediately after the shift to the out-of-service-area state, the acquisition attempt processing of communication systems for the in-area reset is frequently carried out, so a send success rate is low. This is based on the fact that the communication system acquisition attempt processing for the in-area reset is not frequently carried out after a relatively long time has passed, so a possibility of succeeding in the out-of-service-area send operation becomes higher.

The EVDO protocol execution part 183B or “1x” protocol execution part 184B receiving the above instruction executes the acquisition attempt processing based on the set communication system (communication system located at the head of the scan list) (S507).

Then, the EVDO protocol execution part 183B or “1x” protocol execution part 184B informs the communication system selection part 185B of the result of the acquisition attempt by the set communication systems. Here, when the acquisition succeeds (S508 “Yes”), this fact is informed to the acquisition instruction function execution part 186B through the communication system selection part 185B, and the acquisition instruction function execution part 186B receiving this starts up the usual in-area send processing.

On the other hand, when the acquisition fails, the communication system selection part 185B selects a communication system stored at the next position in the scan list and instructs the EVDO protocol execution part 183B or “1x” protocol execution part 184B of the execution of the acquisition attempt processing.

Below, the EVDO protocol execution part 183B or “1x” protocol execution part 184B informs success or failure of acquisition to the communication system selection part 185B in the same way as that described above.

In the above acquisition attempt processing, when a not shown re-try timer reaches a time-out state or there is no longer another communication system stored in the scan list (S509 “Yes”), acquisition failure is informed to the acquisition instruction function execution part 186B through the communication system selection part 185B, and the control part 18B (display control part 182B) makes the display part 16 display failure of a send operation.

Note that, in the present third embodiment described above, an explanation was given by dividing the communication systems covered by the acquisition attempt processing by the out-of-service-area send operation into three patterns according to the elapsed time after shift to the out-of-service-area state. However, the invention is not limited to this. The number of patterns may increase according to the number of communication systems which can be handled by the wireless communication terminal.

As explained above, by determining the communication system covered by the acquisition attempt processing by the out-of-service-area send operation after shifting to the out-of-service-area state based on the out-of-service-area stay time, the opportunities for a send operation at the point of time when a relatively long time has passed from shift to the out-of-service-area state is increased to improve the usability. Further, by making the communication system covered by the acquisition attempt processing by the out-of-service-area send operation immediately after shift to the out-of-service-area state suitable, acquisition attempt processing having a high possibility of becoming useless is eliminated, and the longer battery life can be achieved.

Note that, the wireless communication terminal in principle resets to an in-area state as one aspect, but the consumption of the battery must be suppressed as well as another aspect, therefore a variety of techniques are considered concerning the in-area reset processing consuming large power.

For example, the time from the shift to the out-of-service-area state is divided to a plurality of time limits, for example, the elapse of 10 minutes, the elapse of 30 minutes, and the elapse of 3 hours. Further, another configuration can be considered wherein, when performing the in-area reset processing, the cycle of re-trying the in-area reset is changed for each elapsed time limit so that the in-area reset processing is repeated by a cycle of 2 seconds when the time from shift to the out-of-service-area state is within 10 minutes, the in-area reset processing is repeated by a cycle of 4 seconds when this time is from 10 minutes to 30 minutes, and the in-area reset processing is repeated by a cycle of 4 seconds when this time is from 30 minutes to 3 hours.

In this way, the time limit for changing the in-area reset processing may be used as the standard of judgment for changing the number of communication systems to be acquired in the present invention as well.

Namely, when the time after the in-area reset is up to 10 minutes, it is “immediately after reset from out-of-service-area”, therefore the in-area reset processing is carried out with a high frequency such as the cycle of 2 seconds, so the possibility of acquisition success of communication system is low even if the out-of-service-area send processing is requested. Namely, in an environment where the out-of-service-area send operation is requested and the acquisition of communication system can be made to succeed, the possibility that the in-area reset has previously succeeded is originally high. Accordingly, in this time limit, even if an in-area send operation is carried out, the acquisition processing is carried out for only the communication system a. Then, when the time after shift to the out-of-service-area state is 30 seconds to 3 hours, this is the state “passed from shift to out-of-service-area for a while”, therefore the possibility of in-area reset is considered to be low, and the in-area reset processing is carried out with a low frequency such as a cycle of 8 seconds for saving the power.

That is, before the timing when the out-of-service-area send processing is requested, the acquisition attempt has not been carried out for 8 seconds at the maximum, therefore the possibility that the acquisition can succeed is not low.

Accordingly, when performing the in-area send operation in this time limit, the possibility of success is relatively high, therefore a variety of techniques must be tried, and the acquisition is attempted not only for the communication system a, but also for b and c.

In this way, by applying the time limit for changing the cycle of the in-area reset processing to the present invention as well, it becomes possible to achieve highly efficient out-of-service-area send processing by further considering the possibility of success of the in-area reset processing.

### Fourth Embodiment

Next, an explanation will be given of a fourth embodiment.

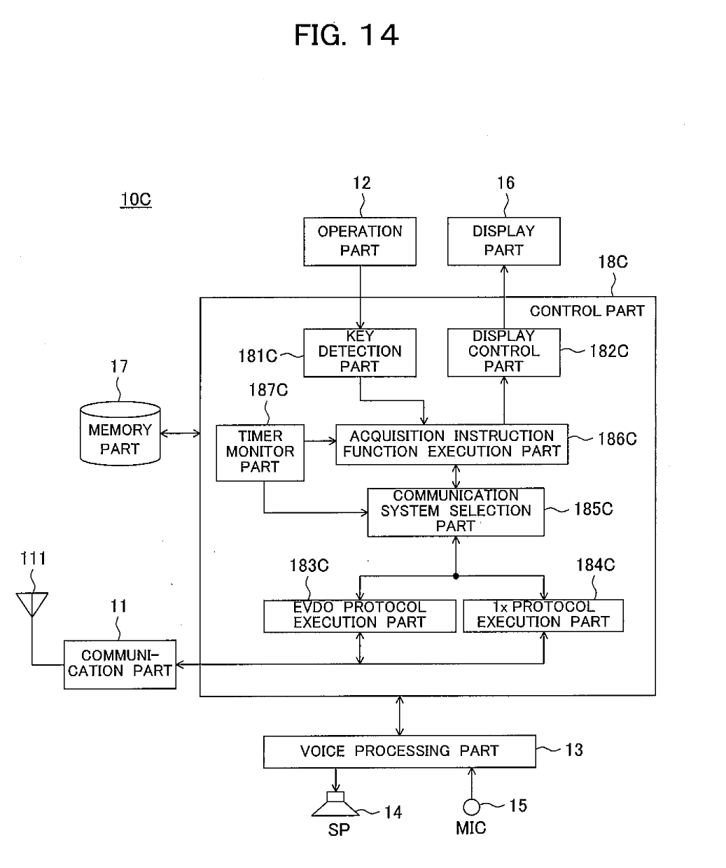

FIG. 14 is a block diagram showing an example of the configuration of a signal processing system of a wireless communication terminal according to a fourth embodiment of the present invention.

A wireless communication terminal 10C according to the present fourth embodiment and the wireless communication terminal 10B according to the third embodiment explained above are same in the basic configurations, but differ in control operations of control parts.

Namely, in the wireless communication terminal 10C according to the fourth embodiment, the control part 18C, when the start of communication is instructed in a state judged “out-of-service-area” in which communication cannot be carried out, instructs the communication part of the acquisition attempt processing so as to acquire a plurality of communication systems in a predetermined order. Then, the control part 18C controls the communication part 11 so as to repeat the acquisition attempt processing N number of times when the predetermined time has not passed from when it was judged as the “out-of-service-area” state and execute the acquisition attempt processing M number of times (where N>M) when the predetermined time has passed.

The control part 18C further has a function of sending to the communication part 11 an acquisition instruction instructing acquisition of any of the plurality of communication systems when the start of communication is requested in a state judged as an “out-of-service-area” state in which communication cannot be carried out by the mobile phone.

The control part 18 is, in the same way as the third embodiment, configured by a key detection part 181C, display control part 182C, EVDO protocol execution part 183C, “1x” protocol execution part 184C, communication system selection part 185C, acquisition instruction function execution part 186C, and timer monitor part 187C.

Note that the functions of these blocks are achieved by running a program stored in the memory part 17 at the control part 18C. These do not indicate only blocks actually built-in the control part 18C discriminated from other blocks and just express the processing parts separated for simplifying the explanation.

The key detection part 181C has a function of detecting a send operation from the operation part 12 and starting up the acquisition processing by the acquisition instruction function execution part 186C.

Further, the display control part 182C has a function of displaying success/failure of the send operation output via the acquisition instruction function execution part 186C in the display part 16.

These key detection part 181C and display control part 182C perform roles as user interfaces.

The EVDO protocol execution part 183C functions as the first protocol execution part instructing the communication part 11 of acquisition by the first communication protocol (EVDO), and the “1x” protocol execution part 184C functions as the second protocol execution part instructing the communication part 1 of acquisition by the second communication protocol (“1x” protocol), and are engaged in communication with the base station 20.

The communication system selection part 185C has a function of instructing the communication part 11 of communication system to be acquired.

The communication system selection part 185C, concretely, sets the time duration for which the acquisition attempt processing is continued in accordance with the elapsed time from when an “out-of-service-area” state is judged to when the acquisition attempt processing is started when the acquisition processing start instruction is made from the acquisition instruction function execution part 186C and that acquisition attempt processing is performed and executes the acquisition attempt processing for this time duration.

Concretely, the communication system selection part 185C makes the EVDO protocol execution part 183C or “1x” protocol execution part 184C perform the acquisition attempt processing with the base station 20.

The acquisition instruction function execution part 186C has a function of sending to the communication system selection part 185C an acquisition attempt processing start instruction of the communication system.

The acquisition instruction function execution part 186C, concretely, when the start of communication is requested in a state where it is judged “out-of-service-area” in which communication cannot be carried out and sends to the communication system selection part 185C an acquisition attempt processing start instruction instructing acquisition of any of the plurality of communication systems. The acquisition instruction function execution part 186C sends to the communication system selection part 185C the acquisition attempt processing start instruction again when the predetermined time has passed before an acquisition success is informed for that acquisition attempt processing start instruction.

Further, the acquisition instruction function execution part 186C performs processing of the start of communication by the successfully acquired communication system when an acquisition success is informed for that acquisition attempt processing start instruction.

The timer monitor part 187C is controlled by the acquisition instruction function execution part 186C and has a function of monitoring the elapsed time after shift to the out-of-service-area state (stay time). Details will be explained later.

Note that, here, the out-of-service-area state means a state where acquisition of communication system cannot be carried out by either the EVDO protocol execution part 183C or “1x” protocol execution part 184C, a state where the display part 6 is made to display the out-of-service-area state by the acquisition instruction function execution part 186C, and a state where the in-area reset processing by the communication part 11 is executed.

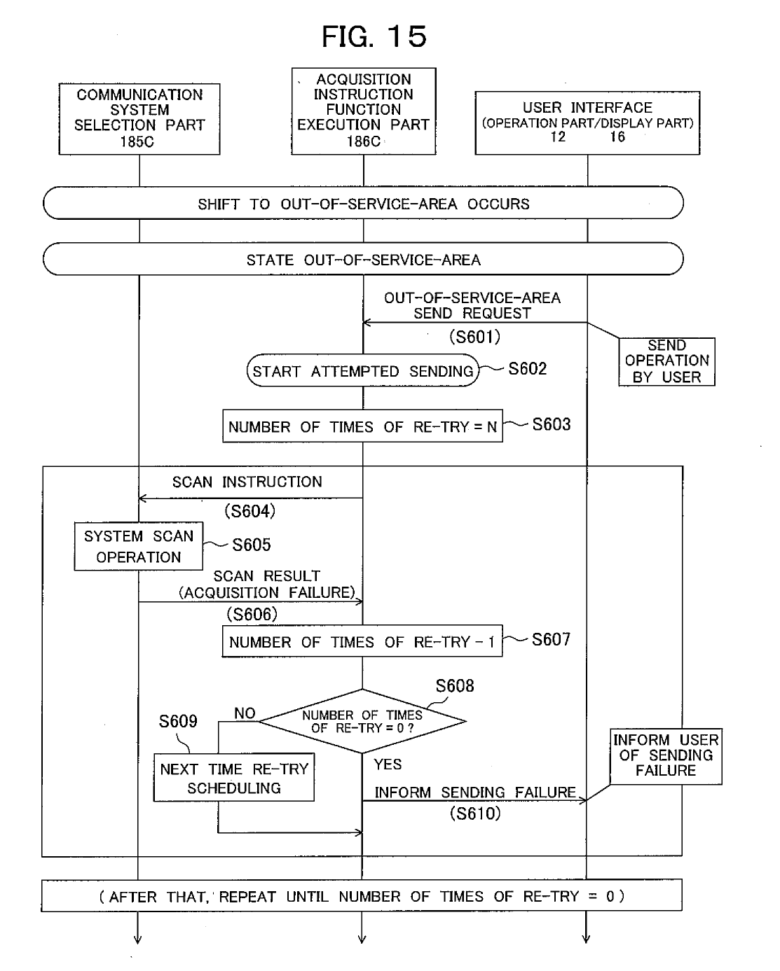

FIG. 15 is a diagram showing a processing sequence of the out-of-service-area send operation (1) of the multiband wireless communication terminal having 11 patterns of communication systems described above.

Here, the flow of processing among the communication system selection part 185C, acquisition instruction function execution part 186C, and user interface (operation part 12/display part 16) is shown.

In FIG. 15, when the wireless communication terminal shifts the out-of-service-area state and detects a send operation of the user or an out-of-service-area send request from an application when it enters the out-of-service-area state (S601), the acquisition instruction function execution part 186C receives this and starts the acquisition attempt processing of communication system by the out-of-service-area send operation (S602).

Here, first, a fixed value N is set in the re-try counter (timer) monitored by the timer monitor part 187C (S603), and a system scan instruction is issued to the communication system selection part 185C so as to execute the acquisition attempt processing of the communication system (S604).

The communication system selection part 185C selects a communication system from a not shown scan list upon receipt of the system scan instruction, makes the same not shown EVDO protocol execution part 183C or “1x” protocol execution part 184C perform the operation of the system scan (S605), and receives the result (success/failure) of the acquisition of that communication system.

Then, the part 183C or the part 184C informs the result to the acquisition instruction function execution part 186C (S606). Note that, in the case of success, the part 183C or the part 184C quickly performs connection processing for a send operation.

The acquisition instruction function execution part 186C, when failing in the acquisition of the communication system, decrease the number of times of re-try by 1 (S607), judges whether or not the number of times of re-try is 0 (S608), and schedules the next re-try (S609) when the result is not 0 (S608 “NO”).

Then, the part 186C instructs the communication system selection part 185C of execution of the operation of the system scan by the next scheduled communication system. After that, the communication system selection part 185C repeatedly executes the system scan operation of the communication system according to the sequence the same as that described above.

The acquisition instruction function execution part 186C starts the send processing if the communication system could be acquired as the result of the system scan operation described above and instructs the communication system selection part 185C again to execute the system scan as an acquisition attempt processing failure if it could not be acquired.

Then, the part 186C repeatedly executes the above acquisition attempt processing for exactly the predetermined time or by a predetermined number of times (re-try counter “0”) (S608 “YES”), performs send processing with the base station 20 if the acquisition attempt processing was successful, and informs the user of sending failure via the user interface (display part 16) if it failed (S610).

The system scan operation by the communication system selection part 185C described above is carried out with reference to a PRL (Preferred Roaming List) for the purpose of raising the sending success rate more and executes the acquisition attempt processing of all of communication systems which can be acquired by the wireless communication terminal.

Here, the PRL is data of a plurality of communication systems stored in correspondence to EVDO and “1x” protocol. The order is defined so that, between EVDO and “1x”, EVDO is given a higher priority in the EVDO, priority is given in an order of 2 GHz, new 800 MHz, and old 800 MHz among a plurality of communication systems, and further a primary channel is selected with a higher priority than a secondary channel.

According to the out-of-service-area send operation (1) in the fourth embodiment described above, the number of times of system scan operation in the out-of-service-area send operation is determined in advance, and that operation is repeatedly executed in a fixed manner. For this reason, for example, an area which is out-of-service-area near an in-area and out-of-service-area border sometimes becomes in-area due to fluctuation of the signal environment, and there is a possibility that the acquisition attempt processing will succeed by executing the system scan a few times and a send operation will become possible even in the same communication system. Accordingly, if the system scan is carried out only one time, there is a possibility of the opportunity of the success of the send operation being lost (loss of sending opportunity).

On the other hand, in a complete out-of-service-area state, even if the system scan operation is executed many times, a communication system cannot be acquired, therefore the possibility of failure in the send operation is high, and a very small number of times of attempting a system scan is sufficient. An acquisition attempt processing more than this becomes useless and useless battery consumption is accompanied with it. In an extreme case, one time may be sufficient. Further, by executing an excessive system scan from when the user performed the send operation to when he acknowledges the result, a delay occurs, so this leads to an increase of user stress.

For this reason, in the out-of-service-area send operation (2) in the fourth embodiment explained below, the timer counting the out-of-service-area stay time is activated when the out-of-service-area state is shifted to, and that timer is referred to when the out-of-service-area send operation is requested.

In the present fourth embodiment, by this, detection of the out-of-service-area state (if the terminal is in an area which is out-of-service-area near the border of in-area and out-of-service-area states or if the terminal is in a complete out-of-service-area state and so on) was carried out according to the comparison result between the timer value and the threshold value which was determined in advance, either of a send operation TMS-A (number of times of re-try=N times) or send operation TMS-B (number of times of re-try=M (where M<N)) was determined, and the suppression of the battery consumption was achieved while securing the opportunity of a send operation. Note that, here, the explanation will be given assuming M=1.

Below, an explanation will be given of the processing sequence of the out-of-service-area send operation (2) of the multiband wireless communication terminal 10C having 11 patterns of communication systems described above.

In the following processing, at the execution of the processing sequence of this out-of-service-area send operation (2), the acquisition attempt processing start instruction is sent to the control part 18C shown in FIG. 14 (communication system selection part 185C) from the acquisition instruction function execution part 186C.

The communication system selection part 185C is given an additional function of making the protocol execution part (the EVDO protocol execution part 183C or “1x” protocol execution part 184C) execute the acquisition attempt processing so as repeat the acquisition attempt processing N number of times when the predetermined time has not passed from when it was judged as the “out-of-service-area” state when performing this acquisition attempt processing and repeat the acquisition attempt processing M (where N>M) number of times when the predetermined time has passed.

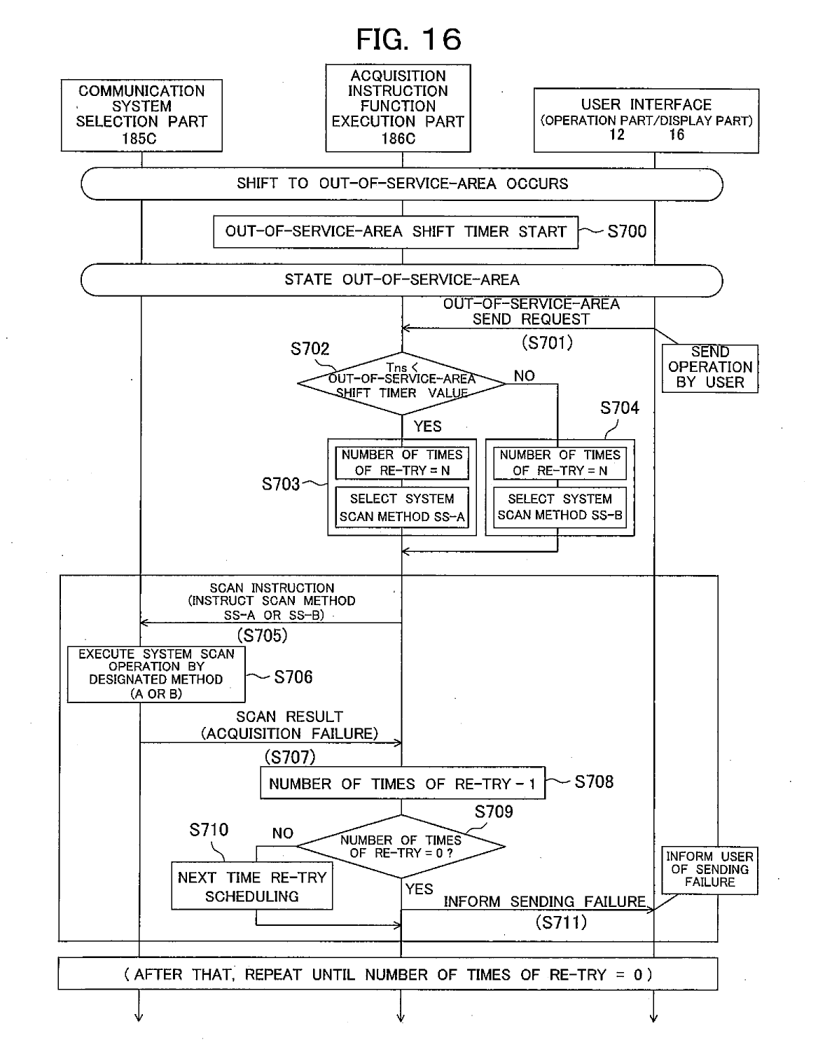

Below, a detailed explanation will be given of the out-of-service-area send operation (2) of the wireless communication terminal 10C according to the present fourth embodiment shown in FIG. 14 with reference to the processing sequence shown in FIG. 16.

In FIG. 16 as well, in the same way as FIG. 15, the flow of the processing among the communication system selection part 185C, the acquisition instruction function execution part 186C, and the user interface (operation part 12/display part 16) is shown.

In FIG. 16, the acquisition instruction function execution part 186C starts the timer counting the out-of-service-area stay time via the timer monitor part 187C at the timing when the out-of-service-area state is shifted to (S700). Here, this timer is called an “out-of-service-area shift timer”.

Next, a send operation by the user is carried out via the user interface (operation part 12) or a send operation is requested via the application. The acquisition instruction function execution part 186C compares the count (out-of-service-area stay time T) by the out-of-service-area shift timer with the out-of-service-area shift timer threshold value “Tns” upon receipt of the send request (S702). Here, when the out-of-service-area stay time T is larger than the threshold value Tns, the number of times of the acquisition attempt processing by the communication system selection part 185C is determined as M (one time) number times, and when the former is smaller than the latter, it is determined as N (where N>M) number of times.

Namely, the communication system selection part 185C repeats the acquisition attempt processing operation N number of times when the predetermined time (Tns) has not passed from when it was judged that the wireless communication terminal was in the out-of-service-area state (S704). When the predetermined time has passed, the communication system selection part 185C makes the EVDO protocol execution part 183C or “1x” protocol execution part 184C execute the system scan so as to repeat the acquisition attempt processing operation M number of times (where N>M) (S703).

Note that, matching with the selection operation described above, for the instructed system scan method, the system scan method SS-A may be selected when the out-of-service-area stay time T is larger than the threshold value Tns, and the system scan method SS-B may be selected when not. Note that, here, the system scan method SS-A is for example one suppressing the number of communication systems for which the acquisition attempt processing is executed in comparison with the system scan method SS-B.

After passing through the above processing, the acquisition instruction function execution part 186C instructs the communication system selection part 185C of a system scan (S705).

The communication system selection part 185C, according to this instruction, selects the communication system specifying the system scan SS-A or system scan method SS-B and makes the EVDO protocol execution part 183C or “1x” protocol execution part 184C start the system scan operation with the base station 20 (S706). Here, when the acquisition succeeds, the connection processing is immediately carried out.

Note that, when the system scan operation described above fails with the base station 20 (acquisition failure), the EVDO protocol execution part 183C or “1x” protocol execution part 184C informs this fact to the acquisition instruction function execution part 186C through the communication system selection part 185C (S707). The acquisition instruction function execution part 186C receiving the acquisition failure notice judges that the acquisition attempt processing failed and decreases the number of times of attempts by 1 (S708).

Then, the acquisition instruction function execution part 186C judges whether or not a remaining number of times of attempts is 0 (S709). When it is 0, the part 186C informs the failure of a send operation to the user interface (display part 16), displays it on the display part 6, and informs the failure of the send operation to the user (S711). When it is not 0, it schedules the acquisition attempt processing operation again and re-tries the system scan (S710).

The above operation is repeatedly executed until the remaining number of times of attempts becomes 0.

As explained above, according to the out-of-service-area send operation (2) according to the fourth embodiment described above, by activating the out-of-service-area shift timer when shifting to the out-of-service-area state and referring to the timer value thereof when the out-of-service-area send operation is requested, the detection of the out-of-service-area state is carried out according to the comparison result between this timer value and the threshold value Tns determined in advance. By determining either of the send operation TMS-A (number of times of re-try=N times) or sending operations TMS-B (number of times of re-try=1), it becomes possible to suppress battery consumption.

As described above, by the detection of the out-of-service-area state and the change of the suitable number of times of re-try in accordance with that, for exampler the loss of the opportunity of a send operation which occurs due to the two out-of-service-area states, for example, being in an area which is out-of-service-area near the border of in-area and out-of-service-area states and being in an area which is completely out-of-service-area, useless battery consumption and increase of the user stress can be eliminated.

### Fifth Embodiment

Next, an explanation will be given of a fifth embodiment.

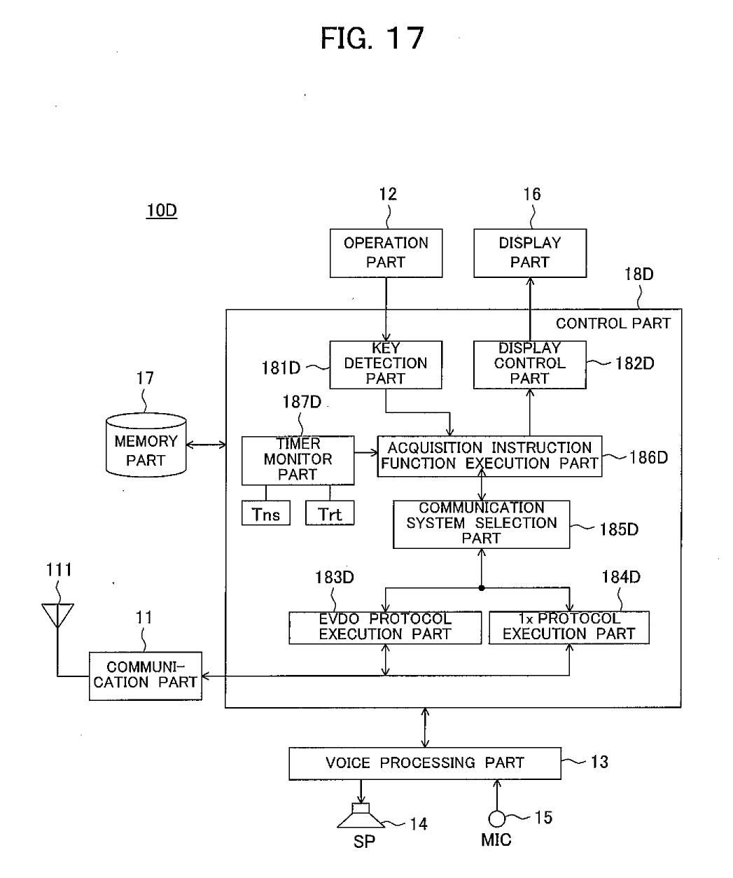

FIG. 17 is a block diagram showing an example of the configuration of a signal processing system of a wireless communication terminal according to the fifth embodiment of the present invention.

A wireless communication terminal 10D according to the present fifth embodiment and the wireless communication terminals 10B and 10C according to the third and fourth embodiments explained above are same in the basic configurations, but differ in control operations of control parts.

Namely, in the wireless communication terminal 10D according to the fifth embodiment, when the start of communication is instructed in a state judged “out-of-service-area” in which communication cannot be carried out, the control part 18D instructs the communication part of the acquisition attempt processing of acquiring any of a plurality of communication systems. Then, the control part 18D sets the time duration for which this acquisition attempt processing is continued in accordance with the elapsed time from when the “out-of-service-area” state was judged.

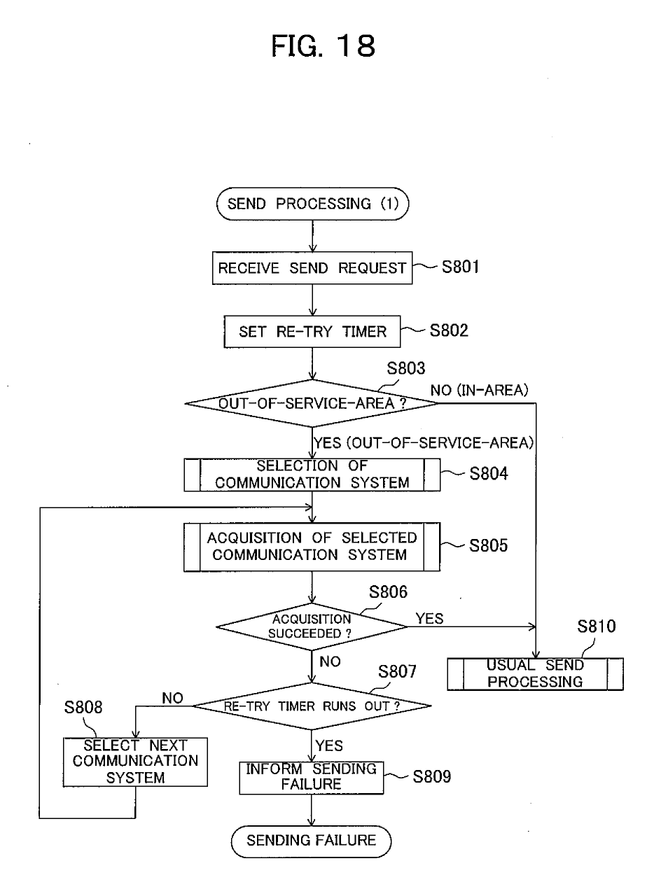

Here, first, an explanation will be given of the out-of-service-area send operation (1) of the multiband wireless communication terminal having 11 patterns of communication systems explained before with reference to the operation flow chart shown in FIG. 18. After that, the configuration and function of the wireless communication terminal 10D of the present fifth embodiment will be explained.

The wireless communication terminal is provided with a scan list in which communication (acquisition) enabled communication systems are stored. As shown in FIG. 18, when an out-of-service-area send request is detected, the wireless communication terminal outputs the acquisition instruction from the communication system stored at the head position of the scan list and executes the acquisition attempt processing of communication systems until the acquisition of the listed communication system succeeds after that (hereinafter, referred to as the system scan).

Concretely, in the flow chart shown in FIG. 18, when detecting the send request (S801), the wireless communication terminal sets a fixed value in the re-try timer (S802) and further judges whether or not the terminal is in the “out-of-service-area” state in which communication cannot be carried out (S803).

Here, the terminal executes the usual send processing when it is judged as an in-area send operation (S810) and executes the out-of-service-area send processing explained later when it is judged as an out-of-service-area send operation.

Namely, the wireless communication terminal, in order to select the communication system covered by execution of the system scan, obtains the communication system stored at the head position of the scan list as the acquisition candidate (S804) and performs the system scan of that communication system first (S805).

Then, when succeeding in the acquisition of that communication system (S806 “Yes”), the wireless communication terminal executes the usual send processing. When it fails (S806 “No”), the wireless communication terminal monitors the time-out state of the re-try timer and, after confirming that the timer has not run out of time (S807 “No”), obtains the communication system stored at the second position in the scan list (S808) and executes the system scan by this communication system (returns to the processing of S805).

The scan of the communication system described above is repeatedly executed for, for example, exactly the 4 seconds set in the re-try timer. Here, when 4 seconds have passed and it is detected that the acquisition by a plurality of communication systems ends to failure (S807 “Yes”), a message of sending failure is displayed on the terminal screen, and the wireless communication terminal shifts to the waiting state (S809).

According to the out-of-service-area send operation (1) described above, the time from the start of the send operation to when the sending failure is informed is uniquely fixed without regard to the possibility of success of the send operation, therefore the opportunity of a send operation is lost or the battery is sometimes uselessly consumed by repeatedly executing useless system scans.

For this reason, in the out-of-service-area send operation (2) explained later, when the elapsed time in the out-of-service-area state in which communication cannot be carried out (stay time) is short, it is not so far from the in-area state. For this reason, by paying attention to the fact that the probability of succeeding in the send operation is high, but the sending success rate is low in a case of long time since it is far away, and changing the time for which the acquisition attempt processing is continued in accordance with the elapsed time when shifting to the out-of-service-area state, the battery consumption is suppressed while securing the opportunity of a send operation.

Note that, here, the “out-of-service-area state” means a state where a communication system cannot be acquired by the protocol execution part explained later (either of the EVDO protocol execution part 183D or “1x” protocol execution part 184D), a state where the acquisition instruction function execution part 186D makes the display part 16 display an out-of-service-area state, and a state where the in-area reset processing by the communication part 11 is executed.

Next, an explanation will be given of the configuration and function of the wireless communication terminal 10D in the present fifth embodiment.

The control part 18D of the present fifth embodiment has a function of sending to the communication part 11 the acquisition instruction instructing acquisition of any of the plurality of communication systems when the start of communication is requested in a state judged “out-of-service-area” in which communication cannot be carried out.

The control part 18D is, in the same way as the first to fourth embodiments, configured by a key detection part 181D, display control part 182D, EVDO protocol execution part 183D, “1x” protocol execution part 184D, communication system selection part 185D, acquisition instruction function execution part 186D, and timer monitor part 187D.

Note that the functions of these blocks are achieved by running a program stored in the memory part 17 at the control part 18. These do not indicate only blocks actually built-in the control part 18D discriminated from other blocks and just express the processing parts separated for simplifying the explanation.

The key detection part 181D has a function of detecting a send operation from the operation part 12 and starting up the acquisition processing by the acquisition instruction function execution part 186D.

Further, the display control part 182D has a function of displaying success/failure of the send operation output via the acquisition instruction function execution part 186D in the display part 16.

These key detection part 181D and display control part 182D perform roles as user interfaces.

The EVDO protocol execution part 183D functions as the first protocol execution part instructing the communication part 1 of acquisition by the first communication protocol (EVDO), and the “1x” protocol execution part 184D functions as the second protocol execution part instructing the communication part 1 of acquisition by the second communication protocol (“1x” protocol), and are engaged in communication with the base station 20.

The communication system selection part 185D has a function of instructing the communication part 11 of communication system to be acquired.

The communication system selection part 185D, concretely, sets the time duration for which the acquisition attempt processing is continued in accordance with the elapsed time from when an “out-of-service-area” state is judged to when the acquisition attempt processing is started when the acquisition processing start instruction is made from the acquisition instruction function execution part 186D and that acquisition attempt processing is performed, and executes the acquisition attempt processing for this set time duration.

Concretely, it makes the EVDO protocol execution part 183D or “1x” protocol execution part 184D perform the acquisition attempt processing with the base station 20.

Note that, the communication system selection part 185D, when instructing the EVDO protocol execution part 183D or “1x” protocol execution part 184D of the communication system to be acquired, refers to the scan list in which communication systems which can be acquired are stored in a predetermined order such as MRU (Most Recently Used) or PRL (Preferred Roaming List) prepared in advance.

The MRU is data in which the order is defined so that the most recently selected communication system is stored at the header position and selected with the highest priority.

Here, the PRL is data of a plurality of communication systems stored in correspondence to EVDO and “1x”. The order is defined so that, between EVDO and “1x” protocol, EVDO is given a higher priority in the EVDO, priority is given in an order of 2 GHz, new 800 MHz, and old 800 MHz among a plurality of communication systems, and further a primary channel is selected with a higher priority than a secondary channel.

In the scan list referred to here, a storage region thereof is secured in the memory part 17 when turning on a power supply, and the data is written one after another whenever the system scan is carried out.

The acquisition instruction function execution part 186D has a function of sending to the communication system selection part 185D an acquisition processing start instruction of the communication system.

The acquisition instruction function execution part 186D, concretely, when the start of communication is requested in a state judged “out-of-service-area” in which communication cannot be carried out, sends to the communication system selection part 185D an acquisition processing start instruction instructing acquisition of any of the plurality of communication systems. The acquisition instruction function execution part 186D sends to the communication system selection part 85 the acquisition attempt processing start instruction again when the predetermined time has passed before the acquisition success is informed for that acquisition attempt processing start instruction.

Further, the acquisition instruction function execution part 186D performs processing of start of communication by the successfully acquired communication system when the acquisition success is informed for this acquisition attempt processing start instruction.

The acquisition instruction function execution part 186D further monitors the elapsed time when the out-of-service-area state is shifted to by the monitoring of the timer by the timer monitor part 187D and sets the time duration for which the acquisition attempt processing by the re-try timer is continued so that it sequentially becomes shorter in accordance with the length of the elapsed time, for example, 40 seconds, 12 seconds, and 4 seconds, when making the EVDO protocol execution part 183D or “1x” protocol execution part 184D perform the acquisition processing.

The timer monitor part 187D is controlled by the acquisition instruction function execution part 186D. Other than the re-try timer described above, an elapsed time timer Tns counting the out-of-service-area stay time is prepared. Monitoring of time is carried out in each.

Accordingly, when the “out-of-service-area” state in which communication cannot be carried out is shifted to, the timer monitor part 187D is activated by the acquisition instruction function execution part 186D, and counting by the timer Tns is started. Note that, the timer Tns is reset to “0” when the wireless communication terminal shifts to the in-area state.

Note that, here, the “out-of-service-area” state means a state where acquisition of communication system cannot be carried out by either the EVDO protocol execution part 183D or “1x” protocol execution part 184D, a state where the display part 16 is made to display the out-of-service-area state by the acquisition instruction function execution part 186D, and a state where the in-area reset processing by the communication part 11 is executed.

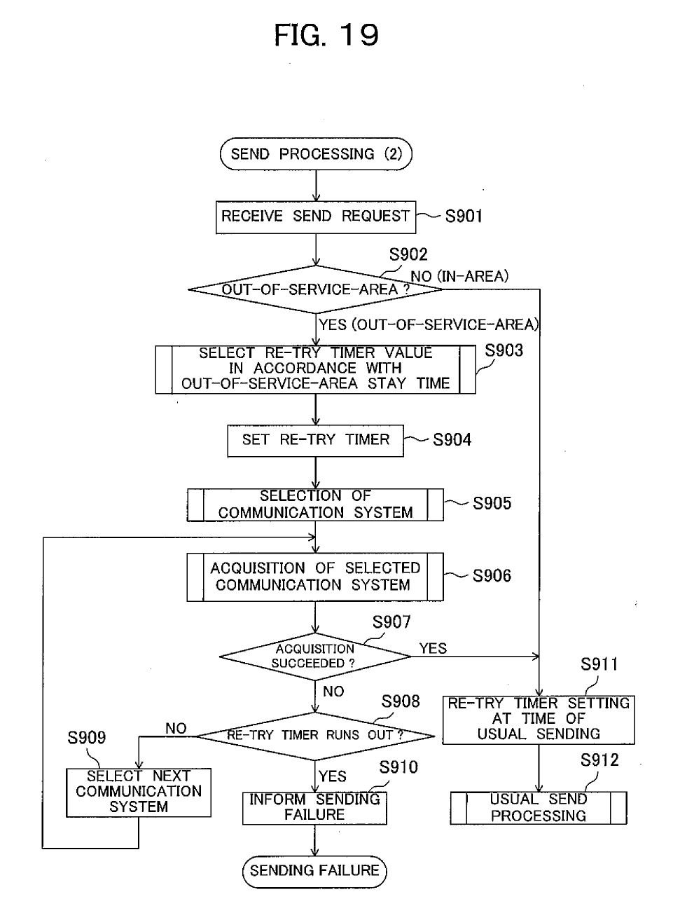

Below, a detailed explanation will be given of the send operation (2) from out-of-service-area of the wireless communication terminal 10D according to the present fifth embodiment shown in FIG. 17 with reference to the flow chart shown in FIG. 19.

First, the send request is generated by the user operating the send key via the operation part 12 or from the application of the wireless communication terminal (S901).

The acquisition instruction function execution part 186D receiving the send request judges if the wireless communication terminal 10D is in the in-area state or the out-of-service-area state at present (S902).

When the judgment is that it is the in-area state (S902 “No”), the acquisition instruction function execution part 186D executes the usual send processing at the time of execution after setting the timer value in the re-try timer at the time of the usual send operation (S911, S912).

On the other hand, when it is judged that it is the out-of-service-area state (S902 “Yes”), the acquisition instruction function execution part 186D activates the timer monitor part 187D and executes the value setting processing of the re-try timer Trt in accordance with the out-of-service-area stay time (S903).

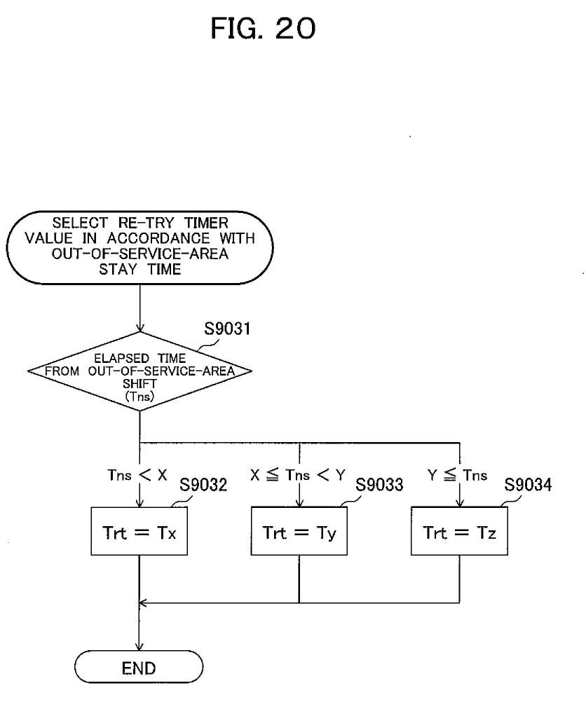

The detailed sequence of the value setting processing of the re-try timer Trt is shown as the flow chart in FIG. 20.

In the flow chart of FIG. 20, the acquisition instruction function execution part 186D refers to the elapsed time timer Tns counting the elapsed time (out-of-service-area stay time) from the shift to the “out-of-service-area” state via the timer monitor part 187D (S9031), determines the re-try timer values Tx, Ty, and Tz of send operations determined in accordance with the out-of-service-area stay times X, Y, and Z (where X>Y>Z), and sets this in the re-try timer Trt via the timer monitor part 187D (S9032 to S9034).

At the setting of re-try timer values Tx, Ty, and Tz, which are the time durations for which the acquisition attempt processing is continued, the setting is made so that the time duration for the acquisition attempt processing becomes shorter in accordance with passing of time in a manner that Tz (for example, 40 seconds) is set when the out-of-service-area stay time is short, Ty (for example, 12 seconds) is set when it is long, and Tx (for example, 4 seconds) is set when it is further longer.

This is based on the fact that the probability of succeeding in a send operation is high in a case where only a short time has passed from shift to the out-of-service-area state since it is not far into the out-of-service-area area, but the sending success rate becomes low when a long time has passed since it is far into the out-of-service-area area.

The explanation is returned to the flow chart of FIG. 19.

After the setting processing of the re-try timer value in accordance with the out-of-service-area stay time (S904), the acquisition instruction function execution part 86 instructs the communication system selection part 85 of the acquisition attempt processing.

The communication system selection part 185D receiving this acquisition attempt processing instruction selects the communication system with reference to the scan list (S905) and makes the EVDO protocol execution part 183D or “1x” protocol execution part 184D execute the system scan (S906).

Next, when the result of the system scan by the communication system selected between the EVDO protocol execution part 183D or “1x” protocol execution part 184D and the base station 20 is that the acquisition is successful (S907 “Yes”), this is informed to the acquisition instruction function execution part 186D via the communication system selection part 185D. The acquisition instruction function execution part 186D receiving this executes the usual send processing after setting the re-try timer at the time of the usual send operation (S911, S912).

On the other hand, when the acquisition fails (S907 “No”), the communication system selection part 185D refers to the re-try timer via the timer monitor part 187D, refers to the scan list when the time-out state is not detected (S908 “No”), and selects the communication system for which the acquisition attempt processing must be carried out next (S909).

Then, it makes the EVDO protocol execution part 183D or “1x” protocol execution part 184D execute the system scan by the selected communication system (S906).

The EVDO protocol execution part 183D or “1x” protocol execution part 184D repeatedly executes the system scan described above for the time set in the re-try timer and informs the failure of a send operation (S910) at the timing when the time-out state is detected (S908 “Yes”).

The acquisition instruction function execution part 186D receiving the acquisition failure notice from the communication system selection part 185D displays the failure of a send operation on the display part 16 via the display control part 182D.

As described above, in comparison with the send processing 1 shown in FIG. 18 in which the send operation was judged a failure after repeating long acquisition attempt processing even in an area predicted to be stable out-of-service-area since the acquisition attempt processing time is fixed regardless of the elapsed time from the shift to “out-of-service-area” and in which stress to the user result, in the send processing 2 shown in FIG. 19, sending success/failure is informed to the user at a time considered to be suitable by setting the time from the success of a send operation to the recognition of the sending failure longer the shorter the time of stay out-of-service-area and by setting the time from the sending success to when the sending failure is recognized shorter the longer the time of stay out-of-service-area, so the stress described above is eliminated and improvement of usability can be expected.

Further, when staying “out-of-service-area” for a long time, the acquisition attempt processing time becomes shorter by making the attempted sending time shorter, therefore reduction of consumed current can be expected and the prolongation of the life of the battery can be achieved.

Note that, according to the embodiments of the present invention described above, a mobile phone was exemplified as the wireless communication terminal 10, but the same effects are obtained even when it is applied to other devices such as a PDA (Personal Digital Assistants), PC (Personal Computer), or game machine.

Further, the functions of the constituent blocks of the wireless communication terminal 10 of the present invention may be all realized by software or at least a portion may be realized by hardware. For example, the processing in the control part 18 and the data processing in the communication part 11 and the voice processing part 13 may be realized in a computer by one or more programs. Further, at least a portion may be realized by hardware as well.

Note that, according to the embodiments of the present invention described above, an example of using EVDO and “1x” communication protocol was explained, but the invention is not limited to this protocol. apparently invention can be applied to a wireless communication terminal using another communication protocol as well.

### INDUSTRIAL APPLICABILITY

According to the present invention, even in a state judged “out-of-service-area”, when a send processing occurs, it is possible to efficiently acquire a communication system and to achieve connection according to the communication scheme desired by the user as much as possible. Therefore, the invention can be applied to a mobile phone or other wireless communication terminal preferably used for a multiband wireless communication system.

1. A wireless communication terminal comprising:
a communication part capable of acquiring a plurality of communication systems and capable of executing communication by a communication protocol; and
a control part which controls communication by the communication part at any of the plurality of communication systems using the communication protocol when a start of communication is instructed,
wherein the control part sends to the communication part an acquisition instruction instructing acquisition of any of the plurality of communication systems when the start of communication is instructed in a state judged “out-of-service-area” in which communication cannot be carried out and performs control of acquisition processing in accordance with an elapsed time from when the “out-of-service-area” state was entered.

2. A wireless communication terminal as set forth in claim 1, wherein the control part controls the communication part so as to perform a first acquisition processing of performing acquisition by a first routine when performing acquisition processing based on an acquisition instruction generated within a predetermined time from when the “out-of-service-area” state was entered and perform a second acquisition processing of performing acquisition by a second routine which is different from the first routine when performing acquisition processing based on an acquisition instruction generated exceeding the first predetermined time from when the “out-of-service-area” state was entered.

3. A wireless communication terminal as set forth in claim 2, wherein the control part has
a communication system selection part instructing the communication part of a communication system to be acquired,
a protocol execution part instructing the communication part of acquisition according to a predetermined communication protocol, and
an acquisition instruction function execution part sending to the communication system selection part an instruction for starting the acquisition processing of the communication system, and
wherein the acquisition instruction function execution part sends to the communication system selection part an acquisition processing start instruction instructing acquisition of any of the plurality of communication systems when the start of communication is requested in a state judged “out-of-service-area”in which communication cannot be carried out and performs processing of the start of communication by a successfully acquired communication system when an acquisition success is informed for the acquisition processing start instruction, and
the communication system selection part makes the protocol execution part perform a first acquisition processing for performing acquisition by the first routine when performing the acquisition processing based on the acquisition instruction generated within the first predetermined time from when the “out-of-service-area” state was entered and makes the protocol execution part perform a second acquisition processing for performing the acquisition by a second routine which is different from the first routine when performing the acquisition processing based on the acquisition instruction generated exceeding the first predetermined time from when the “out-of-service-area” state was entered.

4. A wireless communication terminal as set forth in claim 3, wherein when making the acquisition instruction function execution part perform the acquisition processing, the control part judges if the time is over the first predetermined time by comparing a time when the communication start was requested and a time when the “out-of-service-area” state was shifted to.

5. A wireless communication terminal as set forth in claim 4, wherein the acquisition instruction function execution part sends a new acquisition processing start instruction to the communication system selection part when an acquisition failure is informed from the communication system selection part for the acquisition instruction after performing the acquisition instruction.

6. A wireless communication terminal as set forth in claim 4, wherein the acquisition instruction function execution part sends a new acquisition instruction to the communication system selection part when a success or failure of the acquisition is not informed from the communication system selection part for the acquisition processing start instruction after when the acquisition processing start instruction was sent to the communication system selection part and a second predetermined time has passed.

7. A wireless communication terminal as set forth in claim 4, wherein
the terminal includes a plurality of reference destinations at which communication systems which can be acquired are stored in different orders, and
the communication system selection part switches reference destinations according to an elapsed time after shift to the “out-of-service-area” state and makes the protocol execution part perform either of the first acquisition processing or second acquisition processing based on the switched reference destination.

8. A wireless communication terminal as set forth in claim 3, wherein
the communication protocol includes a first communication protocol and a second communication protocol,
the protocol execution part includes
a first protocol execution part instructing the communication part of acquisition according to the first communication protocol and
a second protocol execution part instructing the communication part of acquisition according to the second communication protocol, and
the communication system selection part selects either of the first protocol execution part and second protocol execution part and makes it perform the acquisition processing.

9. A wireless communication terminal as set forth in claim 1, wherein the control part controls the communication part so as to execute an acquisition attempt processing for n number of communication systems when an elapsed time from the shift to the “out-of-service-area” state to a generation of a communication start request is a first time and execute the acquisition attempt processing for m (where m>n) number of communication systems when it is a second time shorter than the first time.

10. A wireless communication terminal as set forth in claim 9, wherein the control part has
a communication system selection part instructing the communication part of a communication system to be acquired,
a protocol execution part instructing the communication part of acquisition according to the communication protocol, and
an acquisition instruction function execution part sending to the communication system selection part an acquisition attempt processing start instruction of the communication system,
wherein the acquisition instruction function execution part
sends to the communication system selection part an acquisition attempt processing start instruction instructing acquisition of any of the plurality of communication systems when the communication start is requested in a state judged “out-of-service-area” in which communication cannot be carried out,
sends to the communication system selection part an acquisition attempt processing start instruction instructing acquisition of any of the plurality of communication systems again when a predetermined has passed from when the acquisition attempt processing start instruction was sent before an acquisition success for the acquisition attempt processing start instruction is informed, and
performs processing of the start of communication by the successfully acquired communication system when an acquisition success is informed for the acquisition attempt processing start instruction, and
wherein the communication system selection part monitors the time when the acquisition attempt processing start instruction is sent from the acquisition instruction function execution part and the acquisition attempt processing is carried out and makes the protocol execution part execute an acquisition attempt processing for n number of communication systems when the elapsed time from when the shift to the “out-of-service-area” state was made to the generation of the communication start request is the first time and execute an acquisition attempt processing for m (where m>n) number of communication systems when the elapsed time is the second time.

11. A wireless communication terminal as set forth in claim 9, wherein the communication system selection part
performs an acquisition attempt processing acquiring the communication system in a state judged “out-of-service-area” and a state where the communication is not requested and repeatedly executes an in-area reset processing for shifting to an in-area state until reset to in-area state at a predetermined time interval when the acquisition succeeds, and
repeats the in-area reset processing by a predetermined cycle when the elapsed time from the shift to the “out-of-service-area” state to when the communication start request is generated is the first time and performs the in-area reset processing at an interval longer than the predetermined cycle when the elapsed time is the second time.

12. A wireless communication terminal as set forth in claim 1, wherein
the control part instructs the communication part of an acquisition attempt processing so as to acquire a plurality of communication systems in a predetermined order when the communication start is requested in a state judged “out-of-service-area” in which communication cannot be carried out, and
the communication part repeats the acquisition attempt processing N number of times when the predetermined time has not passed from when an “out-of-service-area” state is judged and repeatedly executes the acquisition attempt processing M number of times (where N>M) when the predetermined time has passed.

13. A wireless communication terminal as set forth in claim 12, wherein the control part has
a communication system selection part instructing the communication part of a communication system to be acquired,
a protocol execution part instructing the communication part of acquisition according to the communication protocol, and
an acquisition instruction function execution part sending to the communication system selection part an acquisition attempt processing start instruction of the communication system,
wherein the acquisition instruction function execution part
sends to the communication system selection part an acquisition attempt processing start instruction instructing acquisition of any of the plurality of communication systems in the predetermined order when the communication start is requested in a state judged “out-of-service-area”, and
sends to the communication system selection part the acquisition attempt processing start instruction again when the predetermined time has passed before an acquisition success is informed for the acquisition attempt processing start instruction and performs processing of the start of communication by the successfully acquired communication system when an acquisition success is informed for the acquisition attempt processing start instruction, and
wherein the communication system selection part makes the protocol execution part execute the acquisition attempt processing so as to repeat the acquisition attempt processing N number of times when the predetermined time has not passed from when it was judged as the “out-of-service-area” state when the acquisition attempt processing start instruction is sent from the acquisition instruction function execution part and the acquisition attempt processing is carried out and repeat the acquisition attempt processing M number of times (where N>M) where the predetermined time has passed.

14. A wireless communication terminal as set forth in claim 13, wherein the communication system selection part makes the protocol execution part execute the acquisition attempt processing so as to execute the acquisition attempt processing only one time (M=1) when the predetermined time has passed from when it was judged as the “out-of-service-area” state when the acquisition attempt processing start instruction is sent from the acquisition instruction function execution part and the acquisition attempt processing is carried out.

15. A wireless communication terminal as set forth in claim 13, wherein
the terminal further includes a display part, and
the acquisition instruction function execution part makes the display part display a failure of a send operation when the request of the start of communication was based on a send operation by the user when instructing the communication system selection part to end the acquisition attempt processing.

16. A wireless communication terminal as set forth in claim 1, wherein the control part instructs the communication part of an acquisition attempt processing of acquiring any of a plurality of communication systems when the start of communication is requested in a state judged “out-of-service-area/” in which communication cannot be carried out and sets a time duration for which the acquisition attempt processing is continued in accordance with the elapsed time from when an “out-of-service-area” state is judged.

17. A wireless communication terminal as set forth in claim 16, wherein
the control part has
a communication system selection part instructing the communication part of a communication system to be acquired,
a protocol execution part instructing the communication part of acquisition according to the communication protocol, and
an acquisition instruction function execution part sending to the communication system selection part an acquisition attempt processing start instruction of the communication system,
wherein the acquisition instruction function execution part
sends to the communication system selection part an acquisition attempt processing start instruction instructing acquisition of any of the plurality of communication systems when the communication start is requested in a state judged “out-of-service-area” in which communication cannot be carried out, and
sends to the communication system selection part an acquisition attempt processing start instruction instructing acquisition of any of the plurality of communication systems again when a predetermined has passed from the acquisition attempt processing start instruction before an acquisition success is informed for the acquisition attempt processing start instruction and performs processing of the start of communication by the successfully acquired communication system when an acquisition success is informed for the acquisition attempt processing start instruction, and
wherein the communication system selection part makes the protocol execution part execute the acquisition attempt processing by the selected communication system based on the time duration when the acquisition attempt processing start instruction is sent from the acquisition instruction function execution part and the acquisition attempt processing is carried out.

18. A wireless communication terminal as set forth in claim 16, wherein the terminal further includes a timer monitor part, and the acquisition instruction function execution part stepwise sets the time duration shorter in accordance with a length of the elapsed time counted by the timer monitor part.

19. A wireless communication terminal as set forth in claim 17, wherein
the terminal further includes a display part, and
the acquisition instruction function execution part makes the display part display a failure of a send operation when completing the acquisition attempt processing based on the time duration and instructing the communication system selection part of ending of the acquisition attempt processing in a case where the request of the start of communication was based on the send operation by the user.

20. A communication control method of a wireless communication terminal, the terminal comprising:
a communication part capable of acquiring a plurality of communication systems and capable of executing communication by a communication protocol; and
a control part which controls communication by the communication part at any of the plurality of communication systems using the communication protocol when a start of communication is instructed,
wherein the control part sends to the communication part of an acquisition instruction instructing acquisition of any of a plurality of communication systems when the start of communication is instructed in a state judged “out-of-service-area” in which communication cannot be carried out and performs control of the acquisition processing in accordance with the elapsed time from when the “out-of-service-area” state was entered.

21. A wireless communication system including:
a base station; and
a wireless communication terminal performing wireless communication with the base station through a channel assigned by the base station, wherein
the wireless communication terminal has a communication part capable of acquiring a plurality of communication systems and capable of executing communication according to a communication protocol, and
a control part which controls communication by the communication part at any of the plurality of communication systems using the communication protocol when a start of communication is instructed, and
the control part sends to the communication part an acquisition instruction instructing acquisition of any of the plurality of communication systems when the start of communication is instructed in a state judged “out-of-service-area” in which communication cannot be carried out and performs control of the acquisition processing in accordance with the elapsed time from when the “out-of-service-area” state was entered.
